(19) United States
(12) Patent Application Publication
(10) Pub. No.: US 2025/0244200 A1
(43) Pub. Date: Jul. 31, 2025

(54) OPTICAL IMAGING WITH MULTIMODE WAVEGUIDE AND LENSES

(71) Applicant: LensGuide Imaging Technology, Inc., Rockville, MD (US)

(72) Inventor: Mohammad Amin Tadayon, Rockville, MD (US)

(21) Appl. No.: 19/038,478

(22) Filed: Jan. 27, 2025

Related U.S. Application Data
(60) Provisional application No. 63/625,666, filed on Jan. 26, 2024.

(51) Int. Cl. G01M 11/02; G01M 11/00

(52) U.S. Cl. CPC G01M 11/0292; G01M 11/0207; G01M 11/33

(57) ABSTRACT

An optical system includes a multimode waveguide having a non-circular cross-sectional core for transmission of light and a lens that is optically coupled to the multimode waveguide. The lens directs light from one or more point sources into the multimode waveguide such that the light is transmitted in one or more modes of the multimode waveguide. After transmission, the light is detected at one or more detectable points. In some cases, a back-end lens is configured to receive light that is output from the multimode waveguide. The back-end lens directs the light to one or more detectable points. In some cases, the front-end lens directs light from two or more point sources to the multimode waveguide at different angles relative to a propagation axis of the multimode waveguide such that the light is transmitted via two or more different modes, respectively, of the multimode waveguide.

### BACKGROUND

### Technical Field

The preset disclosure is directed to optical image and data transfer using a multimode waveguide such as a multimode optical fiber.

### Description of the Related Art

Optical imaging, especially in a medical field, and data communication technologies continue to expand in the amount of information to be accurately transferred via data communication channels. Optical microendoscopy, for example, obtains microscopic images of tissue inside a body. Microendoscopy incorporates various technologies for imaging and visualization of tissue at a microscopic scale within biological systems. Several types of microendoscopy technology have been developed for different applications and requirements.

Current microendoscopy tools however face various challenges. For example, microendoscopy tools commonly use GRIN (Gradient-Index) lenses for their ability to achieve a compact size. However, there are challenges with acceptable resolution of GRIN lenses due to various limitations, including limitations on reducing their diameter to e.g., less than 0.5-1 mm, limitations on increasing their length to, e.g., greater than 3-6 mm, and/or limitations on increasing their field of view to, e.g., greater than 30-60%. These limitations can restrict the overall visual coverage of such microendoscopy tools.

Miniaturized lenses are used in endoscopic tools, but they are difficult to deploy in microendoscopy. In particular, it is difficult to achieve a reduced diameter endoscope, e.g., to less than 1-2 mm, with a miniaturized lens due to the complexity of assembling multi-element systems. Even manufacturing a single-element lens with a diameter of less than 1-2 mm is not trivial.

Optical fiber bundles offer another alternative in microendoscopy, with a degree of flexibility and acceptable resolution. However, imaging systems using optical fiber bundles suffer from challenges related to large size, limited field of view, and need for calibration. Such optical fiber bundles may experience significant losses in the light path in each fiber of the bundle. Accordingly, these systems usually require a complicated backend light collection system and frequent recalibration of the system.

Data communication technologies also face challenges in transferring ever larger amounts of data with reasonable and/or heightened accuracy.

### BRIEF SUMMARY

The present disclosure provides solutions that address the challenges described above and other challenges in the fields of optical imaging and data communication.

In at least one embodiment, the present disclosure provides an optical system comprising a front-end lens configured to receive light from one or more point sources; a multimode waveguide that is optically coupled to the front-end lens to receive light from the front-end lens, wherein the light received from the front-end lens is transmitted through the multimode waveguide in one or more modes of the multimode waveguide; and a back-end lens configured to receive light that is output from the multimode waveguide, wherein the back-end lens directs the light to one or more detectable points.

In some cases, the front-end lens directs light from two or more point sources to the multimode waveguide at different angles relative to a propagation axis of the multimode waveguide such that the light from the two or more point sources is transmitted via two or more different modes, respectively, of the multimode waveguide. In some cases, the multimode waveguide has a non-circular cross-section. In some cases, the cross-section of the multimode waveguide has 2, 3, 4, 5, 6, 7, or 8 sides. In the case of 2 sides, some waveguides are called slab waveguides which have an infinite thin plate that is sandwiched between two other infinite plates. Light received by the front-end lens from a point source and transmitted through the multimode waveguide is directed by the back-end lens to the one or more detectable points.

The optical system may comprise a detector configured to detect light at the one or more detectable points and produce a detection signal, and a processor configured to apply a transfer function to the detection signal to produce a system output comprising information that was transmitted in the light from the one or more point sources. In some cases, the transfer function is determined for the one or more detectable points based on a condition of the multimode waveguide.

In at least one case, the information transmitted in the light from the one or more point sources is an image or data communication, and the transfer function is determined based on calibration performed using the multimode waveguide or from a computer simulation of the multimode waveguide. A reference waveguide may be configured to receive and transmit light, and changes in light transmission via the reference waveguide is usable to determine the condition of the multimode waveguide.

In some cases, the optical system further comprises an absorber arranged to selectively absorb at least a portion of the light received from the front-end lens or the light that is output to from the multimode waveguide, thereby limiting the light at the one or more detectable points and simplifying the transfer function that produces the system output.

In some cases, the optical system further comprises multiple front-end lenses configured to receive light from one or more spatially distinct points sources, and multiple mirrors configured to direct light from the multiple front-end lenses, respectively, into the multimode waveguide for transmission in the one or more modes of the multimode waveguide.

The optical system may further comprise one or more additional waveguides arranged to deliver illumination light to an object at the one or more spatially distinct point sources. The one or more additional waveguides may be selectively illuminated so that illumination light is selectively delivered to portions of the object at the one or more spatially distinct point sources.

In some cases, the light from the one or more point sources at a front end of the multimode waveguide originates from a laser scanning system at a back end of the multimode waveguide, wherein light originating from the laser scanning system is optically coupled by the back-end lens into the multimode waveguide, transmitted through the multimode waveguide, and directed by front-end lens to the one or more point sources, to thereafter return as light from the one or more point sources.

The optical system is further configured such that: the front-end lens is configured to receive light from the one or more point sources at a focal plane of the front-end lens and output collimated light; the multimode waveguide is optically coupled to the front-end lens to receive the collimated light at one or more angles relative to a propagation axis of the multimode waveguide and transmit the collimated light through the multimode waveguide in the one or more modes of the multimode waveguide depending on the one or more angles of the collimated light; and the back end lens is configured to direct the light in each mode of the multimode waveguide to the one or more detectable points at a focal plane of the back end lens.

In some cases, the one or more point sources are outputs of an optical data transmitter. In at least some such cases, the optical system further comprises an optical data receiver configured to detect the light at the one or more detectable points. The optical data receiver includes a detector configured to detect the light at the one or more detectable points and output a detection signal; and a processor that applies a transfer function to the detection signal to reconstruct a data signal that was transmitted by the optical data transmitter.

In some cases, the detector is configured to output the detection signal based on light detected only at the one or more detectable points. In some cases, the transfer function is calculated to reconstruct the data signal from the detection signal. The optical data transmitter may be configured to output data signals using light that is multiplexed for simultaneous transmission through the multimode waveguide using two or more modes of the multimode waveguide.

Also disclosed herein are novel and non-obvious methods including a method for optical data transmission. The method includes receiving light from one or more light sources and directing the light by a front-end lens into a multimode waveguide, and transmitting the light through the multimode waveguide in one or more modes of the multimode waveguide.

The method further includes receiving light that is output from the multimode waveguide and directing the light by a back-end lens to a detector arranged to detect the light at one or more detectable points, wherein the detector outputs a detection signal based on the light detected at one or more detectable points, and applying a predetermined transfer function to the data in the detection signal to reconstruct output data originally represented in the light from the one or more light source, the output data representing an image of an object or a data signal transmitted by an optical data transmitter.

In some cases, the method further comprises monitoring one or more conditions of the multimode waveguide and updating the transfer function in response to a change in the one or more conditions of the multimode waveguide. The method may further comprise predetermining the transfer function in a calibration step that includes evaluating the data in the detection signal with respect to a known image or known data signal that was transmitted in the light from the one or more light sources, and adjusting a calculation of the transfer function so that application of the transfer function to the detection signal provides for reconstruction of the known image or known data signal.

In additional embodiments, disclosed herein is an optical system comprising a multimode waveguide having a non-circular cross-sectional core for transmission of light, and at least one lens optically coupled to the multimode waveguide. Light from one or more point sources is directed by the at least one lens into the multimode waveguide such that the light is transmitted via the core of the multimode waveguide in one or more modes. After transmission, the light exiting the multimode waveguide is detected at one or more detectable points.

In some cases, the at least one lens that directs the light into the multimode waveguide also directs the light exiting the multimode waveguide to the one or more detectable points. In other cases, the at least one lens includes a first lens and a second lens, wherein the first lens is arranged to direct the light from the one or more point sources into the multimode waveguide, and the second lens is arranged to focus the light exiting the multimode waveguide in each of the modes to the one or more detectable points. In some cases, the first lens, the multimode waveguide, and the second lens are arranged to transmit light from at least two point sources to one detectable point.

In at least one advantageous implementation, the at least one lens and the multimode waveguide are implemented in a linear optical quantum computing system in which one or more photon sources at the one or more point sources excite one or more modes of the multimode waveguide and photons transmitted in the multimode waveguide interact to create superposed quantum states that are detectable at the one or more detectable points.

Generally, as will be seen from the description here, the light from the one or more point sources contains information. The optical system may include a processor configured to apply a transfer function to a detection signal obtained from detection of the light at the one or more detectable points. Application of the transfer function to the detection signal reconstructs the information. The transfer function is determined from a calibration operation in which the information represents a guide object having known geometry and the transfer function is adjusted so that, when applied to the detection signal, the transfer function reconstructs the information representing the guide object within a threshold accuracy.

### BRIEF DESCRIPTION OF THE SEVERAL VIEWS OF THE DRAWINGS

FIG. 1 graphically depicts an optical system comprised of a lens-multimode waveguide-lens arrangement according to the present disclosure;

FIG. 2(a) illustrates an example in which a front-end lens collimates light received from one or more point sources.

FIG. 2(b) depicts examples of different modes of a multimode waveguide.

FIG. 2(c) depicts a back-end lens that receives light output from the multimode waveguide.

FIG. 2(d) depicts a lens-multimode waveguide-lens arrangement according to the present disclosure.

FIG. 2(e) illustrates ray tracing of light from a point source at the front end of the optical system to multiple detectable points at the back end of the optical system.

FIGS. 3(a) and 3(b) illustrate ray tracing of light from point sources at the front end to different detectable points at the back end.

FIG. 3(c) shows examples of detectable points at the back end resulting from transmission of light through a rectangular waveguide.

FIGS. 4(a) and 4(b) illustrate ray tracing of point sources at the front end of a lens-waveguide-lens arrangement according to the present disclosure.

FIG. 4(c) shows example detectable points at the back end as a result of transmission of light through a circular cross-section waveguide.

FIGS. 5(a) and 5(b) illustrate ray tracing of a point source located off center at the front end of a lens-waveguide-lens system using a multimode waveguide having a hexagonal cross-section.

FIG. 5(c) depicts examples of detectable points at the back end resulting from transmission of the light through the hexagonal waveguide.

FIGS. 6(a) to 6(c) illustrate detectable points (or conjugate points) at the back end of the optical system.

FIG. 7 illustrates examples of objects in the object plane various numbers of point sources of light that are transmitted through a multimode waveguide resulting in detectable conjugate points in the image plane.

FIG. 8 illustrates different optical modes (symmetric and asymmetric) of a multimode waveguide in which each optical mode has a different light propagation angle.

FIG. 9 depicts an example environment in which aspects of the present disclosure are implemented using a microscope communicatively coupled to a computer.

FIGS. 10(a) and 10(b) illustrate a predetermined guide object positioned at a predetermined location at the front end usable to calibrate the optical system including a transfer function that is computed based on the object image produced at the back end.

FIGS. 11(a) to 11(c) show a variety of configurations that can be used when implementing a reference waveguide and an imaging/data transfer waveguide according to the present disclosure.

FIG. 12 illustrates a lens-multimode waveguide-lens arrangement that is utilized to generate an image or pattern at the front end from a pattern or image provided at the back end.

FIG. 13(a) shows an optical data communication link using a lens-multimode waveguide-lens arrangement as described herein with a multi-channel optical transmitter and receiver.

FIG. 13(b) shows a modification of the optical input provided by the transmitter to produce isolated pulse data at a single detectable point received by the receiver.

FIG. 13(c) shows an example in which a transmitter and receiver are arranged on both ends of the waveguide providing the communication link.

FIG. 14(a) illustrates an example in which a front-end lens 1402 is arranged to a side of the multimode waveguide and a mirror redirect light into a mode of the multimode waveguide.

FIG. 14(b) illustrates another example in which multiple front-end lenses are arranged to the side the multimode waveguide with mirrors arranged in respective light paths of the multiple front-end lenses.

FIG. 14(c) shows that light from different locations can be coupled at different angles and utilize different modes of the multimode waveguide to transfer light.

FIG. 14(d) illustrates a configuration in which different illumination waveguides are used for illumination of parts of the object in front of the front-end lenses

FIG. 15(a) is a schematic view of a multimode waveguide and lens that are simulated.

FIG. 15(b) illustrates several plots depicting the energy density of a multimode waveguide-lens system simulated using a finite difference time domain simulation.

FIGS. 16(a) to 16(c) show different filtering using absorptive/nonabsorptive material on the multimode waveguide to remove unwanted or unnecessary secondary image points

FIGS. 17(a) to 17(c) illustrate an example of an input and output of an optical system according to the present disclosure.

FIGS. 18(a) to 18(c) are illustrative of results that occur when using an optical system that is not constructed or operated using the principles of the present disclosure.

FIGS. 19(a) and 19(b) illustrate different configurations for guiding of light in different ways according to the present disclosure.

FIG. 20(a) illustrates how suitable detectors or transmitters may be arranged based on the shape of a conjugate pattern's profile.

FIG. 20(b) illustrates a virtual realization of different forms of detectors or transmitters based on the shape of conjugate patterns.

FIG. 21 graphically depicts how a change of the transmitter location changes the values of its conjugate points produced in the image plane.

FIG. 22 is a graph that illustrates the effect of changes of the waveguide length on the amount of power received at conjugate points in each quadrant of the image plane.

FIG. 23 graphically depicts the effect of a bending radius of a waveguide on the image plane spot size.

FIGS. 24(a) and 24(b) depict the effect of point spread functions on the conjugate points, spot size, and output irradiance which may vary depending on the shape and curvature of the bend of the waveguide.

FIGS. 25(a) to 25(c) show the effect of different shapes of the waveguide (bend) on how the point spread function of the conjugate points varies in the image plane.

FIG. 26 graphically depicts the effect of shaped corners of the multimode waveguide on the location and spreading of the light in the image plane.

### DETAILED DESCRIPTION

The present disclosure provides solutions that address various challenges and shortcomings in current image and data transfer technologies.

Multimode optical fibers (MMF) having circular cross-section waveguides are known for their flexibility and small diameter. Because of an MMF's ability to simultaneously transmit information using light in multiple spatial modes, MMFs could, in principle, replace the millimeters-thick optical fiber bundles currently used in endoscopes with a single fiber only a few hundred microns thick. That, in turn, could potentially open up new, less invasive forms of endoscopy to perform high-resolution imaging of tissues that are out of reach of current conventional endoscopes. However, microendoscopic imaging using current MMF technology suffers from various limitations, including low resolution and the need for complicated algorithms for image processing. Furthermore, complicated recalibration of the system is typically required after bending the MMF, which adds to the complexity of the setup.

The challenges faced by current microendoscopy tools highlight areas where further development and refinement are needed. Described herein are optical systems that address these challenges and enhance image quality, increase clinical applications, and improve diagnostic, surgical, and therapeutic outcomes. The optical systems described herein utilize technologies that optimize imaging algorithms, enhance resolution and image quality, and address issues related to system size, flexibility, and calibration, especially for microendoscopic tools. As will be understood from the description herein, these aims are achieved in various embodiments by coupling the information from each point source on the object plane/transmitter side in only one mode of a multimode waveguide and collecting the light in each mode of the waveguide only in a few points on the image plane/receiver side.

Optical systems according to the present disclosure include combinations of multimode waveguides and lenses for use in an optical system. In the field of microendoscopic imaging, these combinations are useful to achieve a microendoscopic probe having a small diameter, long length, and high resolution, with a simple transfer function for imaging. A small diameter microendoscopic probe is valuable so as to minimize damage to tissue during insertion of the probe into the tissue. A long length is beneficial as it allows the microendoscopic probe to be inserted deeper into the biological system as needed to obtain an image of target tissue in-depth. A high resolution is valuable in order to accurately image the target tissue. A simpler transfer function allows for significantly less complicated calculations that in turn enables faster imaging and faster and less complicated calibration of the optical system.

In various examples described herein, the optical system includes (but is not limited to) a front-end lens, a waveguide, and back-end lens. Advantageously, the waveguide may be an optical multimode waveguide, though in some cases, the optical system may be achieved using a single mode waveguide. The front-end lens, which may be a single lens or a set of lenses, is arranged or positioned with respect to (e.g., in front of) the multimode waveguide. The back-end lens, which may be a single lens or a set of lenses, is arranged or positioned with respect to an opposite end (e.g., a back end) of the multimode waveguide.

The front-end lens and the back-end lens may be any type of lens or set of lenses as needed for the application in which the optical system is used. For example, a diffractive lens, a meta-lens, or any type of light phase manipulator can be incorporated into the optical system. In addition, the lenses on front end and back end can be different from each other.

The waveguide may be suitable waveguide including, for example, a regular step function waveguide, a gradient index waveguide, a hollow waveguide with mirrors on its sides (sometimes considered a light pipe), or waveguides with different cross-sectional shapes, e.g., as illustrated in FIGS. 19(a) and 19(b). The cross-sectional shapes may have any type of rounded or non-rounded corners.

The front-end lens is configured to transfer light received from one or more point sources (e.g., a pixel or voxel) of an object being imaged to one or more eigenmodes (or “modes”) of the multimode waveguide. The light is then transmitted through the multimode waveguide in the one or more modes of the waveguide. Advantageously, information in the light transferred from a point source to a mode of the multimode waveguide does not cross-talk with information in light transferred from another point source to another mode of the multimode waveguide. At the back end of the multimode waveguide, the back-end lens is configured to transfer the light from each mode of the multimode waveguide to a single or multiple image points, e.g., at a focal plane of the back-end lens. The number of image points produced for each point source by the back-end lens depends on factors such as the shape of the waveguide, the length of the waveguide, and the location of the corresponding point source of light at the front-end lens.

The optical system further includes an optical detector at the back-end lens. The optical detector is preferably arranged at the focal plane of the back-end lens. The optical detector is configured to receive and detect locations and intensities of the light at the focal plane of the back-end lens. In various examples, the optical detector may be one or more photodetectors arranged in a planar or nonplanar configuration or array to detect the intensity of the light from the back-end lens. In some cases, an optical imaging system such as microscope can be used as an optical detector to receive and detect locations and intensities of the light. In some cases, the optical detector comprises photodetectors forming pixels of a camera sensor. In some cases, a single substrate detector may be used in which the substrate is capable of detecting the locations and intensities of the incoming light.

The optical detector detects the intensity of the light by measuring, for example, the optical power of the light (e.g., power per unit area of the photodetector (W/cm2)) at each detection location, and generates an output signal or signals. Thereafter, a transfer function is applied to the output signal(s) of the optical detector to compute an image. As discussed herein, the transfer function of the optical system may be a relatively simple algorithm determined by a calibration operation and stored in a memory for retrieval and use during imaging operations that compute an image output.

As mentioned above, the number of image points at the focal plane of the back-end lens from light transmitted through the multimode waveguide depends, at least in part, on the shape of the multimode waveguide. More specifically, it is found that the number of image points at the focal plane of the back-end lens directly depends on the number of sides in a cross-section of the multimode waveguide through which the light was transmitted. In one example, an optical system using a multimode waveguide having a square cross-section may generate up to four image points at the focal plane of the back-end lens from light received from a single point source of the object being imaged. Alternatively, in another example, an optical system using a multimode waveguide having a hexagonal cross-section may generate up to six image points at the focal plane of the back-end lens. In an example where the optical system uses a multimode waveguide having a circular cross-section, the number of image points at the focal plane of the back-end lens may essentially be infinity since the number of “sides” of the circular waveguide is infinity.

The multiple image points at the focal plane of the back-end lens are detected by an optical detector and the resulting output signals from the optical detector are processed according to a transfer function implemented by one or more computer processors to generate an image of the original object being imaged. In some examples, the transfer function may be a linear function, which can simplify the calculations needed to generate the image of the object. The transfer function used in various examples of the present disclosure are significantly simpler and more robust since each point source of light received at the front end is only coupled to one mode of the multimode waveguide. The transfer function described herein may be determined (e.g., by calculation) using experimental or theoretical functions and if not linear, it is considered that the transfer function will be close to a linear function.

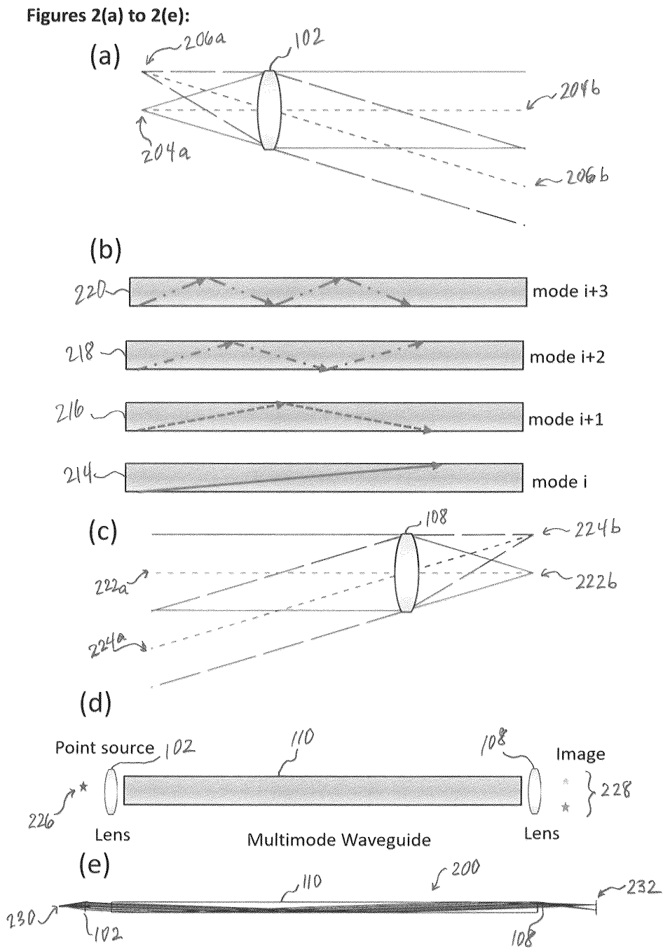

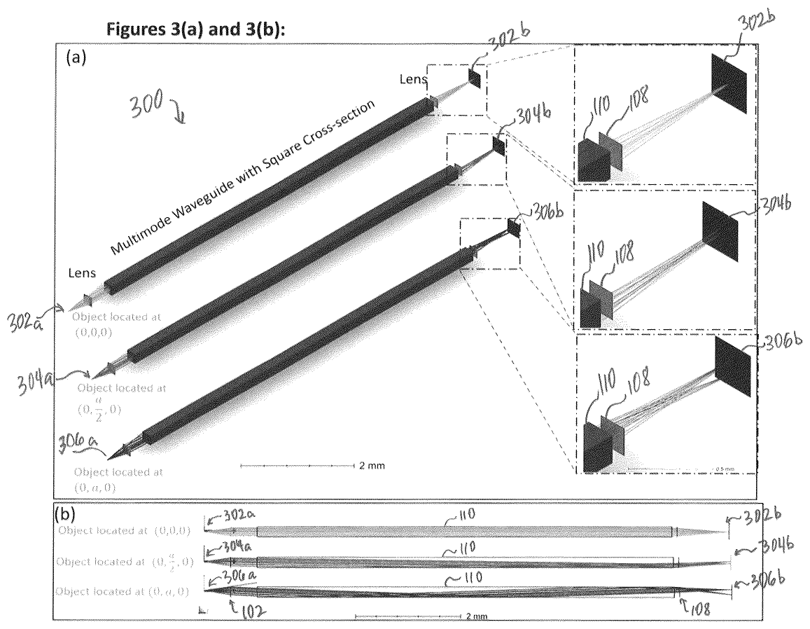

Thus, the principal technical features of the optical systems of the present disclosure include a “lens-waveguide-lens” arrangement, e.g., as shown below in FIG. 2(d). In such arrangement, one or more lenses are positioned at the front end of a multimode waveguide, and one or more lenses are positioned at the back end of the multimode waveguide. In some examples, using a single lens at the front end of the multimode waveguide may be advantageous to facilitate optical coupling of each point source of light from the object to a specific mode of the multimode waveguide. Coupled to the “lens-waveguide-lens” arrangement is an implementation of light detection and processing, e.g., by an optical detector and processor, that takes into account that the number of image points at the focal plane of the back-end lens related to the number of the sides in a cross-section of the multimode waveguide. As will be understood from the present disclosure, light originating at points at either end of the multimode waveguide will produce detectable light at corresponding conjugate points at the other end of the multimode waveguide.

In many implementations, it is preferred to use a multimode waveguide having a non-circular cross-section so as to reduce ambiguities of the image produced by the back-end lens and simplify the transfer function that ultimately is used to generate the image output. Using non-circular multimode waveguides instead of circular waveguides results in a fewer number of image points at the focal plane of the back-end lens that correlate to a point source of light from the object being imaged at the front end. In particular, it is contemplated that a multimode waveguide having a rectangular cross-section is preferred, to make the transfer function easier to construct.

The transfer function (or transfer matrix) is used to convert the output of the lens-waveguide-lens system to the (true) image of the object. Any mathematical calculations can be used for the conversion of the output of the lens-waveguide-lens system to the true image. This includes using an inverse matrix or simplifying the transfer function to sets of m×m equations (where m is number of sides of the waveguide), having non-linear transfer function, etc.

Various methods may be used to determine the transfer function of an optical system as described herein. For example, in some cases, the intensity of light at the point source(s) of the object being imaged at the front end may be considered I_{object}, while the intensity of the light at locations on the optical detector at the focal plane of the back-end lens may be considered I_{camera}, where the number of pixels of the optical detector (e.g., the camera sensor) is N.

For simpler notation, a 2D image matrix may be converted to 1D vector. For calibration of the optical system, at the front end, a point source of light is arranged at a kl pixel with power of 1, and by way of optical detection at the back end, multiple points of light are observed. The multiple points of light (producing signals representing an “image”), as detected by the optical detector, are saved in the k^{th} column of an N×N transfer matrix T. The point source of light is moved to different pixel locations at the front end, with resulting optical detection at the back end ultimately filling the transfer matrix T. Depending on the number of pixels in the optical detector (camera sensor), the noise level, and the quality of the optical system, the number of nonzero elements in the produced image (transfer matrix column) for each point source of light can be as low as the number of sides of the cross-section of the waveguide. After determining the transfer matrix T, the inverse of the transfer matrix T is generated and stored in a memory accessible to the optical system (i.e., one or more processors of the optical system). The inverse of the transfer function is used to generate an object image from the signals produced by the optical detector.

In other words:

$${I}_{camera} = {TI}_{object}$$

$${I}_{object} = {T}^{- 1} {I}_{camera}$$

Various examples of the present disclosure may use different methods for determining the transfer matrix T. For example, the transfer matrix T may be calculated using ray transfer and wave transfer technologies applied to the lenses and multimode waveguide of the optical system.

As described herein, the multimode waveguide may be straight (without any bending) or it may be curved due to the design of the waveguide or constraints of the optical system or its application requiring a mechanical bend of the waveguide. If there is a curvature in the lens-waveguide-lens portion of the optical system, the optical system still works the same as described herein. It is in the calculation of the transfer function (e.g., transfer matrix T) that curvature in the multimode waveguide is considered. If the curve is introduced later, after an initial determination of the transfer function (e.g., due to mechanical bending in deployment or any other reason), the optical system will still operate, but the transfer function (transfer matrix) will need to be re-calculated or calibrated. For most needle microendoscopy applications, this will not be required since the multimode waveguide (in the needle) is expected to remain straight.

Examples of the optical system described herein may use a “star” guide in the process of calculating or calibrating the transfer function. In the case of unknown bending of the optical system, e.g., when guiding the waveguide of the optical system through blood vessels, calibration of the transfer function during imaging becomes necessary. See, e.g., FIG. 2(d), described below. In that case, the object being imaged on the front-end side of the optical system can be replaced by one or a few pixels of a known object (i.e., a star guide). The amount of angle change (or waveguide bend) in the light path (i.e., the multimode waveguide) can be estimated by finding the change in the location of the image point(s) in the back end from the star guide. By finding the angle change in the multimode waveguide, the transfer function can be updated. The update in the transfer function can be based on theoretical/analytical simulations or on a look-up table from experimental testing. The test and simulations can be preformed previously or during the usage of the lens-multimode-lens system.

Additional examples described herein include aspects of an aperture and/or a mode filter. The optical system may be configured with an aperture on the front-end lens, the multimode waveguide, or the back-end lens. Adding an aperture on the front-end or back-end lens may help filter unwanted rays of light and produce a clearer image. As for a mode filter, the multimode waveguide can be engineered to avoid propagation of certain modes, or to excite or transfer light to one or more additional modes of the waveguide. By way of one example, filtering or exciting a new mode can be achieved by changing the size or profile of the multimode waveguide along the light path of the waveguide.

Light transfer and image generation by the optical system may be accomplished in either direction of the lens-waveguide-lens arrangement, from the front end to the back end, or from the back end to the front end. In other words, instead of having an object to be imaged at the front end and using the optical system to generate a corresponding image at the back end, the optical system can alternatively be used to generate an image or pattern at the front end based on an image or pattern provided or present at the back end. If the image to be generated at the front end has an intensity profile and positioning of I_{front_end}, it is necessary to generate the image I_{back-end} at the necessary location and image intensity at the back end. This can be observed by the following equation used to generate the image I_{front-end} at the front end:

$${I}_{back - end} = {TI}_{front - end}$$

Even though the description herein appears to mainly emphasize imaging, the same front-end lens, multimode waveguide, and back-end lens arrangement can be applied to transfer optical signals between an optical transmitter and an optical receiver of an information communication system. In cases where the multimode waveguide is long or where the pulse width of the input light signal is short, differences in time delay between different modes of the multimode waveguide need to be considered when determining the transfer function (e.g., transfer matrix T). Each column of the transfer matrix may be associated with a specific mode and will have an associated time delay. The time (or phase) delay may be incorporated by using a complex number in the transfer function.

Furthermore, use of the lens-waveguide-lens arrangement of the optical systems described herein can help increase the number of channels between an optical transmitter and optical receiver (e.g., to potentially thousands of channels) while using a relatively simple transfer function. The optical systems may use a single color (wavelength) light source or a few color (wavelengths) light source. The techniques herein can be used to generate, transmit, and receive light pulses in an optical transmitter/receiver system.

As will further be understood from the description below, a variety of materials and configurations may be used to achieve the inventive aspects of the present disclosure.

In the description below, the term “point source” means any kind of source of light such as a true point source, any laser source, a light transmitter, a small or large part of any object, a fluorescence bead, a small or large part of a tissue, light output of a photonic chip, light output of another optical system, light output of any lens system, light output of any optical system, etc.

Due to time reversal symmetry of light, use of the terms “front end” and “back end” can be swapped without changing the functionality of the optical system.

For example, the lens at the front end and/or the back end can be any type of lens, such as (without limitation) a refractive lens, a diffractive lens, a meta-lens, a GRIN lens, any optical configuration that can be used to form an image or focus the light, or any other type of light phase manipulator or a mixture of different types of lenses.

In some implementations, the arrangement may include only one lens in front of the waveguide to excite only one mode of the waveguide.

The cross-section of the multimode waveguide can vary in the number of sides or in the shape of the cross-section. For example, the cross-section of the multimode waveguide can be circular or have concave and/or convex sides (e.g., bean shaped), or any other shape.

The cross-sectional shape and/or the material of the multimode waveguide may vary along the light path of the waveguide. The multimode waveguide can be a photonic crystal fiber or waveguide or any other type of optical waveguide. The material of the core and cladding of the multimode waveguide may vary along the light path of the waveguide. Furthermore, the refractive index profile and/or the extinction coefficient of the material forming the waveguide can follow any function.

The multimode waveguide can be fabricated on a substrate, such as a silicon chip. Alternatively or in addition, one or more multimode waveguides herein may be fabricated off-chip. In various implementations, the multimode waveguide can be an optical fiber or any other realization of a multimode waveguide.

The lenses at the front end and/or the back end of the multimode waveguide might be attached to the waveguide or be arranged separate from the waveguide. The optical system described herein may be supported by a housing or casing having a variety of forms, including (but not limited to) a needle, a cannula, or any type of cabling.

In some implementations, the multimode waveguide may be hollow (e.g., a light pipe with mirrors on its sides).

A star guide, when used, can be arranged on a different plane than the object plane to decrease potential cross-talk/interference between the image of the star guide and an object being imaged. When the star guide is located on a different focal plane, it might need to be imaged by the lens this is focused on the star guide plane. Focusing on the star guide plane can be achieved, for example, by a partial change in the front-end lens, using a different wavelength to image the star guide and the object, using a separate lens, or using variable focus lenses, etc.

The front-end lens and/or the back-end lens may comprise a multi-lens system arranged on a tip of or adjacent to the front end or the back end of the multimode waveguide.

An optical system may include multiple lens-waveguide-lens arrangements as described herein. In some implementations, this includes a cascade of lenses and multimode waveguides. Multiple optical waveguides can also be used to realize the optical system of the present disclosure.

A predetermined calibration image (e.g., a star guide) can be used for calibrating or recalibrating the optical system, e.g., to account for any changes in the light path of the lens-waveguide-lens arrangement, such as changes in the lenses or bending of the multimode waveguide or other changes that occur along the length of the multimode waveguide, including changes in material properties or refractive index of the multimode waveguide.

In implementations using an optical transmitter and receiver, the optical transmitter (light source) and/or the receiver (light detectors) at the front end and/or the back end of the optical system can be used for calibrating or recalibrating the optical system as needed. The inventive aspects of the present disclosure may be used with any type of optical transmitter and receiver.

The point sources of light at the front end and/or the detectors at the back end of the optical system might be on the focal plane of the front-end lens or back-end lens, or might not be on the focal plane of the lenses. In either case, when calibrating the optical system, the determination of the transfer function described herein takes into account such variation.

In some cases, there is a possibility that the multimode waveguide will experience twisting (e.g., an axial twist) along the light pathway, or the number of sides of the waveguide or waveguides may vary along the light pathway, or other physical variations may be present that increase the number of image points produced at the back end to be more than the number of sides of the waveguide initially encountered. For example, depending on the amount and type of twist of the multimode waveguide, twisting of the waveguide may cause light in one mode to excite one or more additional modes of the waveguide. The lens-multimode waveguide-lens system described herein helps decrease resulting ambiguities in the transfer function that may otherwise occur in such cases, helping make the calibration or recalibration of the optical system significantly easier.

In implementations using an optical transmitter and receiver, the transmitter may be, in some cases, an array of Vertical-External-Cavity Surface-Emitting Lasers (VECSEL) or any other light emitters, and the receivers may be an array of photodetectors or any other converter of photons to electrons. Alternatively or in addition, an optical/photonic processor (which does not necessarily convert the light signal to an electric signal) may be deployed to generate a resulting output image.

In some cases, an edge or grating coupler or any other optical element may be used to excite or capture the light at the front end or back end of the lens-multimode waveguide-lens system.

In some cases, multiple lenses (like a lens array) may be used instead of one lens at the front end or back end to capture light at the front end or form an image at the back end.

Different optical elements/configurations may be used to realize collimated light beams (or plane waves) to excite optical modes of the multimode waveguides. Furthermore, different optical elements/configurations may be used to focus (converge) modes exiting out of or emitted from the multimode waveguide at certain points.

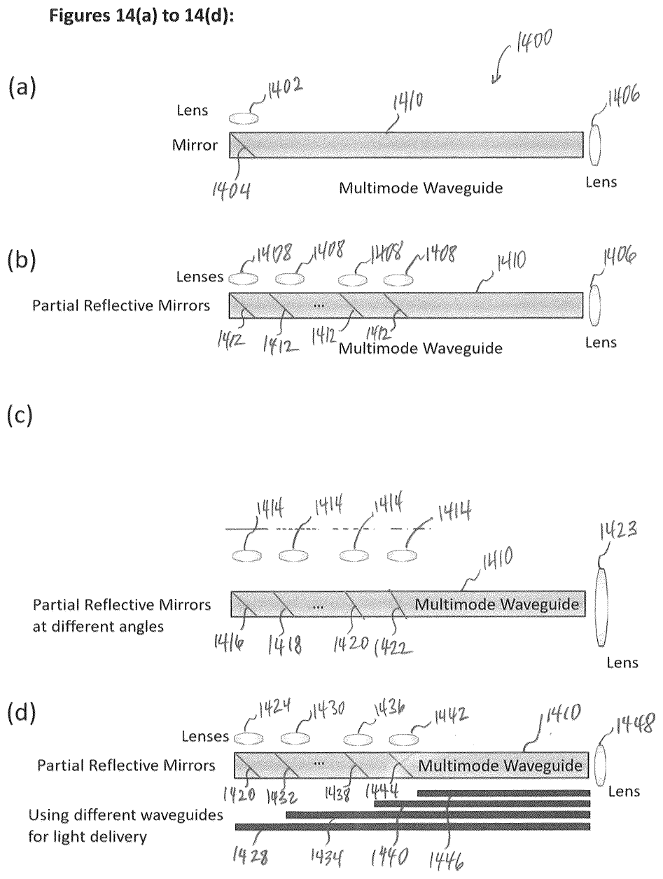

For imaging applications, the delivery of light can be through a different waveguide or waveguides than a main multimode waveguide. A delivery waveguide or waveguides may be used to illuminate an object at different locations, for example, different depth of tissue in a biological system. See, e.g., FIG. 14(d) described below. In this implementation, the lens-multimode waveguide-lens arrangement may be used only for capturing the light. In some implementations, the object being imaged may be illuminated through a lens-multimode waveguide-lens arrangement and the capturing of the transmitted image may be achieved through a different waveguide or waveguide arrangement.

Some implementations may use a cascade of mirrors (reflective or partially reflective) and lenses in the light path to capture images at different depths. See, e.g., FIG. 14(c) described below. In some cases, the mirrors in the cascade of mirrors may be constructed to reflect light at different wavelengths. The same waveguide may illuminate the object and capture light from the object during imaging. In this manner, the cascade of mirrors (with different reflection spectra) and lenses in the light path enables the capturing of images from different depths of the object being imaged.

Light from different parts of an object (e.g., at different locations or different depth) can be coupled to the multimode waveguide at different angles, in different modes of the waveguide. Some realizations of such an optical system include embedding the mirrors at different angles along the multimode waveguide or arranging the mirrors to change the angle of the light in the front-end lens system.

In the lens-multimode waveguide-lens system, the number or locations of image points at the back end resulting from a point source at the front end may vary by the length (optical length) and curvature (light path) of the multimode waveguide. Changing the length (for example, by cutting the waveguide or changing its refractive index), using a different length of the multimode waveguide (different design length), or changing the light path in the multimode waveguide (for example, by bending the multimode waveguide) can be used to change the number or location of the image points produced at the back end from a point source at the front end.

A variety of quantum interactions may be realized using the interaction of photons in the lens-multimode waveguide-lens system or in a multimode waveguide-lens system. This may be accomplished by introducing interferences between different photons and different quantum states. The same mode or different modes of the multimode waveguide may be used to introduce these interferences. Modifying the number of the sides of the waveguide may be used to modify the number of these interferences/interactions. The strength of the interactions between different modes may be changed by modifying the light path such as bending the multimode waveguide, changing the strain in the multimode waveguide, changing the refractive index in the multimode waveguide, etc.

In some embodiments, the system may be configured to capture or transfer only part of the light from the object in front of the lens-waveguide-lens system to partially image the object and achieve a simpler transfer function. This can be realized by, for example, filtering light from part of the object using variety of methods such as adding an aperture in the light path, changing a cross section of the waveguide, or covering part of the waveguide by a pattern of absorptive or non-absorptive material to remove some modes or remove part of one or more of the modes.

The lens-multimode waveguide-lens may be used to transfer light from an object through the waveguide and form an image using different imaging modalities, such as optical coherence tomography, fluorescence imaging, two photon imaging, confocal microscopy, and photography, for example.

The system can be arranged to change or excite different modes of a multimode waveguide-lens or lens-multimode waveguide-lens arrangement to change the angle of light coming out of the multimode waveguide-lens or lens-multimode waveguide-lens arrangement. This arrangement may be applied in any light scanning system such as, for example, in laser imaging, detection, and ranging (lidar), augmented reality (AR) glasses, virtual reality (VR) glasses, any optical microscopy, or any optical imaging.

By way of at least one non-limiting example, the present disclosure includes an optical system that comprises:
a front-end lens configured to receive light from one or more point sources;
a multimode waveguide that is optically coupled to the front-end lens to receive light from the front-end lens, wherein the light received from the front-end lens is transmitted through the multimode waveguide in one or more modes of the multimode waveguide; and
a back-end lens configured to receive light that is output from the multimode waveguide, wherein the back-end lens directs the light to one or more detectable points.

The optical system may be configured for imaging, e.g., microendoscopic imaging, or for information communication, e.g., data communication. Thus, the one or more point sources may be one or more point sources of light from an object being imaged or one or more point sources of light emitted by a transmitter for data communication.

The front-end lens may be a single lens or a set of lenses. Alternatively or in addition, the back-end lens may be a single lens or a set of lenses.

The one or more point sources may be at a focal plane of the front-end lens. The one or more detectable points may be at a focal plane of the back-end lens.

The front-end lens may output light, e.g., collimated light, at one or more angles relative to an optical axis of the multimode waveguide. The light from the front-end lens may be introduced into and transmitted through the multimode waveguide in one or more modes of the multimode waveguide depending on the angle of the light relative to the optical axis of the multimode waveguide.

In various embodiments, it has been found advantageous to construct the multimode waveguide with a limited number of sides in the cross-section of the waveguide. It has been found that the cross-sectional shape of the multimode waveguide affects the number of detectable points (conjugate points) of light produced by the back-end lens. Decreasing or reducing the number of sides of the waveguide is advantageous because it acts to reduce the number of detectable points at the back end that result from transmission of light from a point source at the front end. Decreasing the number of detectable points at the back end in turn decreases ambiguity of the resulting image and complexity of the calculation required by the transfer function (e.g., the number of terms in the transfer function) to reconstruct the image or the data transmitted. A simpler transfer function leads to simpler calibration of the optical system (e.g., in the event of changes in the light path), faster image reconstruction, and less demand for computational resources. This contrasts with current technologies that communicate light in a conventional manner through a waveguide, e.g., fiber-optic communication using circular fiber optic waveguides. As will be understood from the description and figures provided below, embodiments of the present disclosure may advantageously use a multimode waveguide having a non-circular cross-section (e.g., a waveguide having a rectangular, hexagonal, etc., cross-section) for imaging or data transfer. Using a waveguide having a non-circular cross-section with a limited number of sides may achieve significantly better performance.

As noted earlier, the optical system may include an optical detector configured to receive light from the back-end lens and detect an output parameter such as power, energy, or intensity of the output light at one or more locations of the detectable points. In various embodiments, the optical detector produces corresponding detection signals that are processed according to a transfer function to generate a system output (e.g., an output image or output data for communication). The optical detector may be positioned at the focal plane of the back-end lens.

The transfer function may be determined by computer simulations or by a calibration step, e.g., using a predetermined calibration image such as provided by a star guide. The transfer function may comprise an inverted transfer matrix that is calculated during the computer simulations or calibration step and later applied to the detection signals to generate the system output.

It should be noted that for data transfer, the lens-waveguide-lens system described herein may advantageously increase the number of channels (equivalent to or affecting data rate) that can be used for transmitting data across the multimode waveguide 110. For current single-mode fibers, only one channel is available without wavelength multiplexing. For current multimode fibers, typically only 1-10 channels are used without wavelength multiplexing due to problems of mixing data across the modes.

In contrast, using the lens-waveguide-lens system described herein, the number of channels for data transmission can be increased to 1000-10000 without wavelength multiplexing. This is achieved, as discussed herein, by placing the data transmitters and receivers at the detectable points (also referred to herein as conjugate points) at the back end and front end of the waveguide 110.

For imaging, e.g., related to FIGS. 11(a) to 11(c) discussed below, when using a reference line, it may be advantageous to cover part of the image plane with a partial or full absorber, or a partial or full mirror, to use the reference line as a reference or to receive information from fewer conjugate points on the object plane, instead of all of the conjugate points on the object plane. For example, in embodiments using a square-shaped waveguide, three quadrants of the object plane may be covered by an absorber (absorbing all of light that comes from three-fourths of the object). At the image plane, to reconstruct the image of each point source or pixel of of the object on the object plane, the optical system in this case may only require summing the light from the conjugate points at the image plane, and in such implementations, a transfer function as described herein may not be necessary or used.

Concepts described above for imaging can also be used for data transfer and data communication technologies. A transmitter may transmit data using only part of the transmitter (object) plane, virtually or by actual placement of the transmitters), to simplify the transmitter calculations. For example, when using a square-shaped waveguide, the transmitters may be arranged on only one quadrant of the transmitter (object) plane to transfer data. On the receiving side, the system may sum the light at all of the conjugate points on the receiving plane to recover the signal from each transmitter (channel). In some cases, this sum can be obtained optically through a photonic circuit that collects all of the light from the conjugate points, using for example mixing waveguides. Such summing may alternatively be done by an analog circuit, by converting the light intensities to an analog signal through a photodetector and then summing the analog signals. It can also be done by converting the optical signal from each receiver to a digital signal and summing the digital signals.

By way of another non-limiting example, an optical system as described herein may comprise:
a front-end lens configured to receive light from one or more point sources at a focal plane of the front-end lens and output collimated light;
a multimode waveguide optically coupled to the front-end lens to receive the collimated light at one or more angles relative to an optical axis of the multimode waveguide and transmit the collimated light through the multimode waveguide, wherein the collimated light is transmitted in one or more modes of the multimode waveguide depending on the one or more angles of the collimated light; and
a back-end lens configured to receive output light from the multimode waveguide, wherein for light transmitted in each mode of the multimode waveguide, the back-end lens focuses the output light to one or more detectable points at a focal plane of the back-end lens.

In various embodiments, the multimode waveguide has a defined number of sides (i.e., having a non-circular cross-section), and in cases, the number of sides in the cross-section of the waveguide may be reduced. As explained herein, advantages are achieved by decreasing the number of sides of the waveguide as this can reduce the number of detectable points at the back end. Decreasing the number of detectable points decreases ambiguity of the resulting image. It also reduces the number of terms in the transfer function needed to reconstruct the image or data at the back end.

Additional understanding of the optical systems and methods described herein is achieved in reference to the drawings and the following corresponding description of example embodiments.

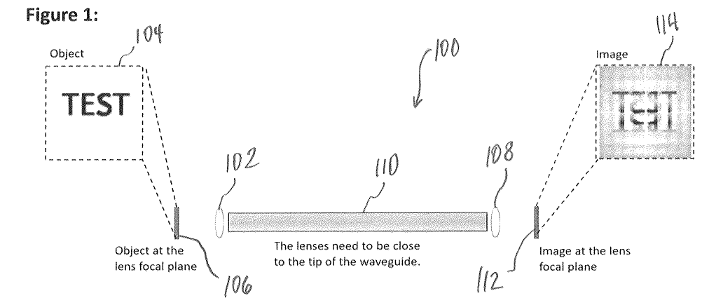

FIG. 1 depicts an example of a lens-multimode waveguide-lens system 100 that includes a front-end lens 102 and a back-end lens 108 with a multimode waveguide 110 arranged therebetween. The lenses 102 and 108 are respectively located before and after the waveguide 110. For better performance, the lenses 102, 108 generally need to be close to the respective tips or ends of the waveguide 110.

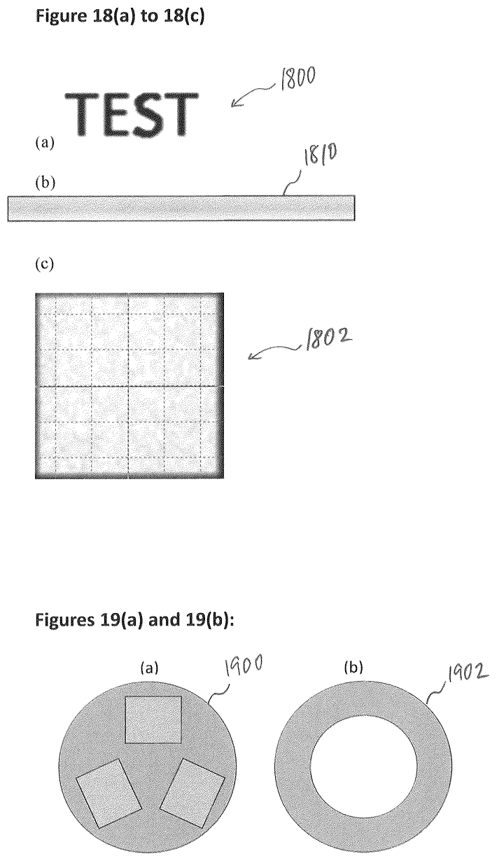

The invention described herein differs from current conventional practice. See, e.g., Rahmani, B., Loterie, D., Konstantinou, G., Psaltis, D., & Moser, C., Multimode optical fiber transmission with a deep learning network. Light: Science & Applications, 7(1), 69 (2018), in which an object is placed on the input side of a circular multimode optical fiber. In some cases, a replica of the object is created by a relay system at the input of the optical fiber. The replica might be magnified/demagnified by the relay system on the object side. After the light from the object is transferred through the optical fiber, an image appearing as a jumbled pattern (similar to FIG. 18(c)) at the output of the optical fiber is transferred through another relay system to a camera and captured by the camera. This method, which uses a lens only to relay the object to the input of the optical fiber or to relay a pattern output from the optical fiber to the camera, differs from the present invention.

As described herein, light rays are emitted or reflected from an object 104 at a focal plane 106 of the front-end lens 102, such as the TEST object in FIG. 1, and directed by the front-end lens 102 into the multimode waveguide 110 for transmission. The light rays are transmitted via different modes of the multimode waveguide 110 to the waveguide back end. The back-end lens 108 captures the light rays from each mode of light as they exit the waveguide 110 at a certain respective angles with respect to the waveguide's optical axis. The back-end lens 108 focuses the light rays from each mode (or angle with respect to the waveguide axis) to specific locations at a focal plane 112 of the back-end lens 108. The light rays are detected, e.g., by an optical detector and processed to reconstruct an image of the object 114, such as the TEST image shown in FIG. 1.

FIG. 2(a) illustrates an example in which the front-end lens 102 collimates light received from one or more point sources 204a, 206a located at different points of the focal plane of the front-end lens 102. The collimated light is transmitted by the front-end lens 102 at different angles relative to an optical axis of the front-end lens. For example, collimated light from the point source 204a may be centered around an axis 204b that is inline with the optical axis of the front-end lens, while collimated light from the point source 206a may be focused by the frond-end lens 102 around an axis 206b. The optical axis of the front-end lens 102 may in turn correspond to a propagation axis of the multimode waveguide 110 that is optically coupled to the front-end lens 102 (see FIG. 1).

FIG. 2(b) depicts examples of different modes of a multimode waveguide. Collimated light from the front-end lens received at different angles by the multimode waveguide is optically coupled into and transmitted through the multimode waveguide in the different modes of the waveguide. For instance, in example 214, light received by the multimode waveguide at a first angle may be transmitted through the waveguide according to mode i along a first optical path as shown. In example 216, light received by the multimode waveguide at a second angle may be transmitted through the waveguide according to mode i+1 along a second optical path. In example 218, light received by the multimode waveguide at a third angle may be transmitted through the waveguide according to mode i+2 along a third optical path, while in example 220, light received by the multimode waveguide at a fourth angle may be transmitted through the waveguide according to mode i+3 along a fourth optical path.

FIG. 2(c) depicts a back-end lens 108 that receives light output from the multimode waveguide 110. Light exiting from the multimode waveguide 110 at different angles is received by the back-end lens 108 and focused to one or more detectable points on a focal plane of the back-end lens. For example, light transmitted according to one mode and centered around an axis 222a may be directed by the back-end lens 108 to a detectable point 222b, while light transmitted according to another mode and centered around an axis 224a may be directed by the back-end lens 108 to a detectable point 224b.

FIG. 2(d) depicts a view of a lens-multimode waveguide-lens arrangement contemplated by FIGS. 1(a) to 1(c), including for example a combination of a front-end lens 102, a back-end lens 108, and a multimode waveguide 110 as shown in FIG. 1. The lens-multimode waveguide-lens arrangement 100 transfers light from a point source 226 to a single point or multiple points 228 that are detectable at the focal plane of the back-end lens 108. The point source 226 at the front end (here illustrated by a small star) is located in front of the front-end lens 102, e.g., at the focal plane of the front-end lens.

As described with respect to FIG. 2(a), the front-end lens 102 collimates the light from the point source 226 and outputs light at an angle with respect to the optical axis of the multimode waveguide 110. Light received by the multimode waveguide 110 at different angles is optically coupled to one or more different modes of the multimode waveguide. The multimode waveguide 110 conveys or transmits the light in the different modes to the back end of the waveguide. The light is output from the back end of the multimode waveguide 110 at different angles, as described with respect to FIG. 2(c). The back-end lens 108 directs the light to one or more detectable points 228. In the example illustrated in FIG. 2(d), the back-end lens 108 produces two detectable points 228, represented by two small stars as shown. One star appears lighter than the other star, representing different intensities of the light at the two detectable points 228.

FIG. 2(e) illustrates one example of ray tracing 200 of light from a point source 230 at the front end of the optical system to multiple detectable points 232 at the back end of the optical system. As described herein, the number of detectable points 232 at the back end is proportional to a number of sides, s, of the cross-section of the multimode waveguide 110. Rays of light from the multimode waveguide 110 are output at one or more angles with respect to the propagation axis of the waveguide 110. The light output from the waveguide 110 may propagate in s different directions at respective angles relative to the propagation axis of the waveguide 110. In the example shown, with a waveguide 110 having a square cross-section, the back-end lens 108 may direct the light output from the waveguide 110 to one to four detectable points 232 at the focal plane of the back-end lens 108. FIG. 2(e) depicts an example in which two detectable points 232 at the back end result from light received from the point source 230 at the front end of the optical system.

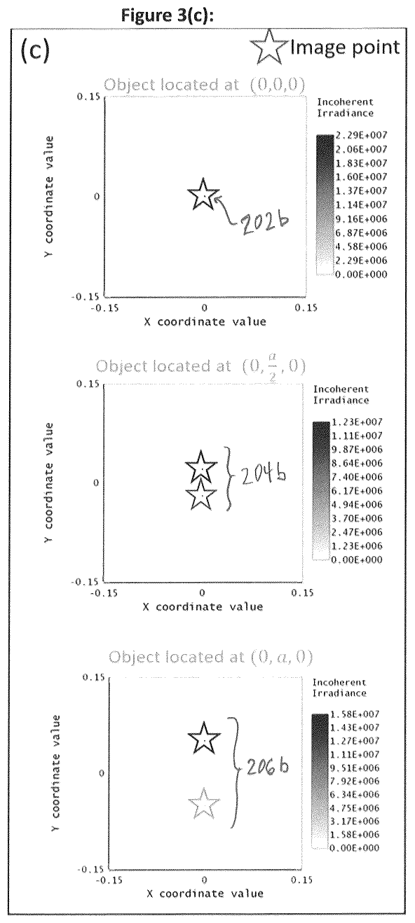

FIGS. 3(a) and 3(b) illustrate ray tracing 300 of light from point sources 302a, 304a, and 306a that are respectively located, for example, at coordinates (0,0,0), (0,α/3, 0), and (0, α, 0) in front of the lens-waveguide-lens arrangement 100 of the optical system. In these examples, the multimode waveguide 110 has a square cross-section.

FIG. 3(a) shows a three-dimensional ray tracing 300 of the light rays from the three example point sources 302a, 304a, and 306a at the front end to different detectable points 302b, 304b, and 306b at the back end. In the example of light from the point source 302a, the lens-waveguide-lens arrangement 100 produces a single detectable point 302b at the back end. In the example of point source 304a, the lens-waveguide-lens arrangement 100 produces two detectable points 304b at the back end spaced close together, while in the example of point source 306a, the lens-waveguide-lens arrangement 100 produces two detectable points 306b at the back end spaced farther apart. See, e.g., FIG. 3(c) discussed below. For reference, FIG. 3(b) shows a two-dimensional side view of the ray tracing 300 for the three example point sources shown in FIG. 3(a).

FIG. 3(c) shows example locations of detectable points of the light at the back end resulting from transmission of the light through a rectangular waveguide as illustrated in FIGS. 3(a) and 3(b). Because the detectable points are small dots, the detectable points are highlighted in FIG. 3(c) using a star-shaped border that surround the detectable points. The star-shaped borders are included solely for convenience for purposes of highlighting the detectable points. The darkness of each dot (and the surrounding star-shaped border in this illustration) represents the detected intensity or amount of irradiance of the light at the detectable points, which can be different at different detectable points. See, e.g., the gradient scale for incoherent irradiance provided with each of the examples shown in FIG. 3(c).

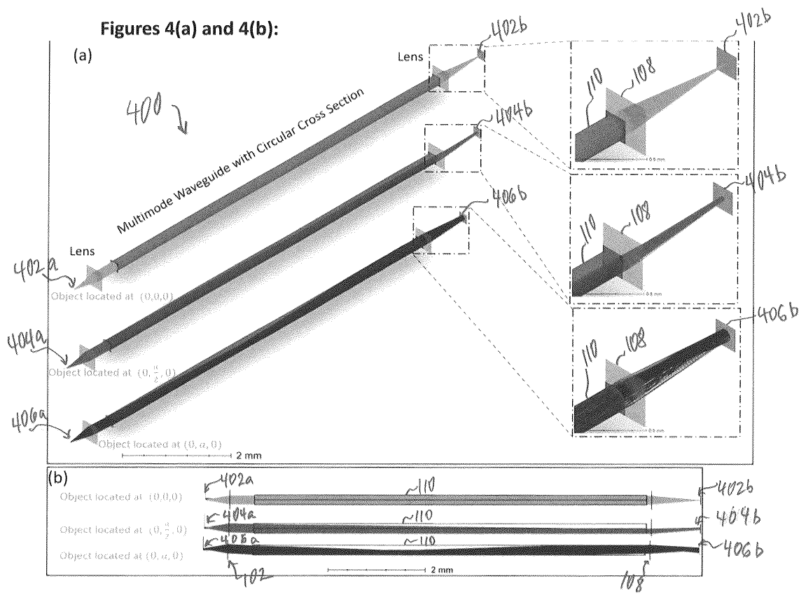

Depending on the location of the respective point source at the front end relative to the square cross-section of the multimode waveguide, the output of the back-end lens at the back end of the optical system may produce one to four detectable points. In other implementations where the multimode waveguide has a different cross-sectional shape, the number of detectable points at the back end may be different. As explained herein, decreasing the number of sides of the waveguide can reduce the number of detectable points at the back end resulting from a point source of light at the front end. Compare, for example, the non-ambiguous detectable points resulting at the back end from transmission of light though a square cross-section multimode waveguide as shown in FIG. 3(c) to the more ambiguous detectable points that result from transmission through a circular cross-section multimode waveguide as shown in FIG. 4(c).

FIGS. 4(a) and 4(b) illustrate ray tracing 400 of point sources 402a, 404a, and 406a that are located, for example, at (0,0,0), (0,α/2, 0), and (0, α, 0) at the front end of the lens-waveguide-lens arrangement 100, e.g., as illustrated in FIG. 1. In this example, the multimode waveguide 110 has a circular cross-section.

In particular, FIG. 4(a) shows a three-dimensional ray tracing 400 of the light rays from the three example point sources 402a, 404a, and 406a at the front end to different detectable points 402b, 404b, and 406b at the back end. The number of detectable points appears to form a circle at the focal plane of the back-end lens, which is possibly considered an infinite number of detectable points since the number of “sides” of a circle may be considered infinite. In the example of point source 402a, the lens-waveguide-lens arrangement 100 having a circular cross-section produces a detectable point 402b at the back end. The detectable point 402b may be circular, though with a small radius. In the example of point source 404a, the lens-waveguide-lens arrangement 100 produces a circular detectable point 404b at the back end with a larger radius, while in the example of point source 406a, the lens-waveguide-lens arrangement 100 produces a circular detectable point 406b at the back end with even a larger radius. See, e.g., FIG. 4(c) discussed below. For reference, FIG. 4(b) shows a two-dimensional side view of the ray tracing 400 for the three example point sources shown in FIG. 4(a).

FIG. 4(c) shows example locations of detectable points of light at the back end as a result of transmission of light through a circular cross-section waveguide as illustrated in FIGS. 4(a) and 4(b). With a circular waveguide 110, when the point source 402a at the front end is located at a central location (0,0,0), possibly along a propagation axis of the waveguide 110, the light at the back may be directed by the back-end lens 108 to a centrally-located detectable point 402b. If the point source of light at the front end is located at other locations, e.g., point source 404a at (0, a/2, 0) or point source 406a at (0, a, 0), the detectable points 404b and 406b at the back end may appear to be larger, less defined circles, suggesting an infinite number of detectable points. This demonstrates a disadvantage of using a circular cross-section multimode waveguide. According to the present disclosure, use of a non-circular waveguide, such as a square or rectangular cross-section waveguide (e.g., as illustrated in FIGS. 2(a) to 2(c)), or a hexagonal waveguide as illustrated in FIGS. 4(a) and 4(b)), for imaging or data transfer reduces the number of detectable points at the back end, which in turn decreases ambiguity of the detectable points and decreases the complexity of a transfer function used for reconstructing the image or data that was transmitted. This leads to simpler calibration of the system, less demand on computational resources, and faster image or data reconstruction.

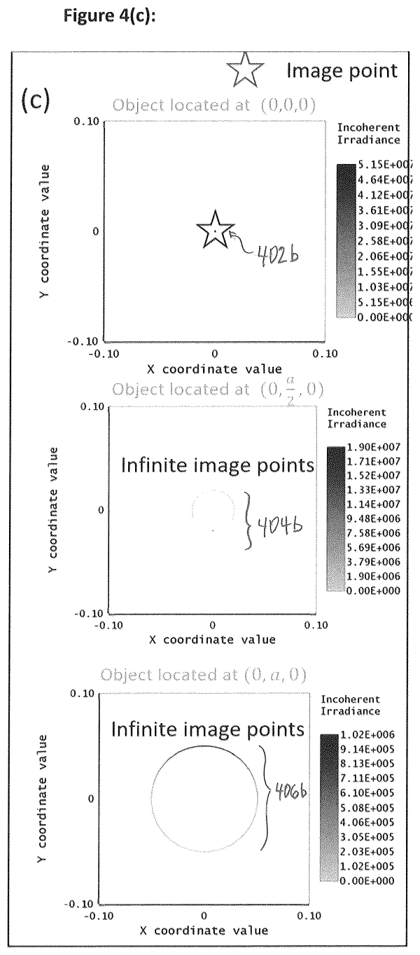

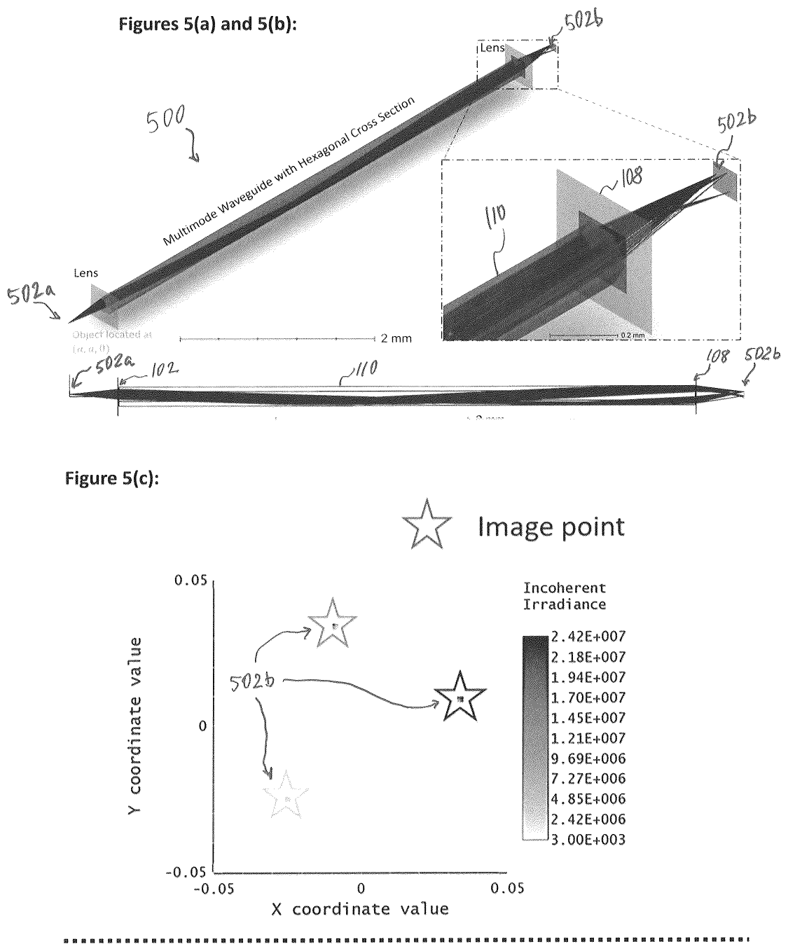

FIGS. 5(a) and 5(b) illustrate ray tracing 500 of a point source 502a that is located off center, e.g., at (α, α, 0) in front of the lens-waveguide-lens system 100. In this example, the multimode waveguide 110 has a hexagonal cross-section.

FIG. 5(a) shows a three-dimensional ray tracing 500 of the light rays from the point source 502a at the front end to different detectable points 502b at the back end. In this example, the lens-waveguide-lens arrangement 100 produces three detectable points 502b at the back end spaced apart from each other. See, e.g., FIG. 5(c) discussed below. FIG. 5(b) shows a two-dimensional side view of the ray tracing 500 for the example point source 502a shown in FIG. 5(a).

FIG. 5(c) shows example locations of the detectable points of the light at the back end resulting from transmission of the light through the hexagonal waveguide in FIGS. 5(a) and 5(b). In this example, three detectable points 502b are generated at the back end by the point source 502a at the front end. Star-shaped borders are used to highlight the detectable points 502b. This example demonstrates that the number of detectable points increases and may be proportional to the number of sides of the waveguide cross-section. Depending on the location of the respective point source 502a at the front end relative to the hexagonal cross-section of the multimode waveguide 110 in this case, the output of the back-end lens 108 at the back end of the optical system may produce one to six detectable points.

The darkness of each dot representing the detectable points (and the surrounding star-shaped borders shown for convenience) represents different detected intensities or amount of irradiance of the light at the detectable points 502b. See, e.g., the gradient scale for incoherent irradiance provided in FIG. 5(c).

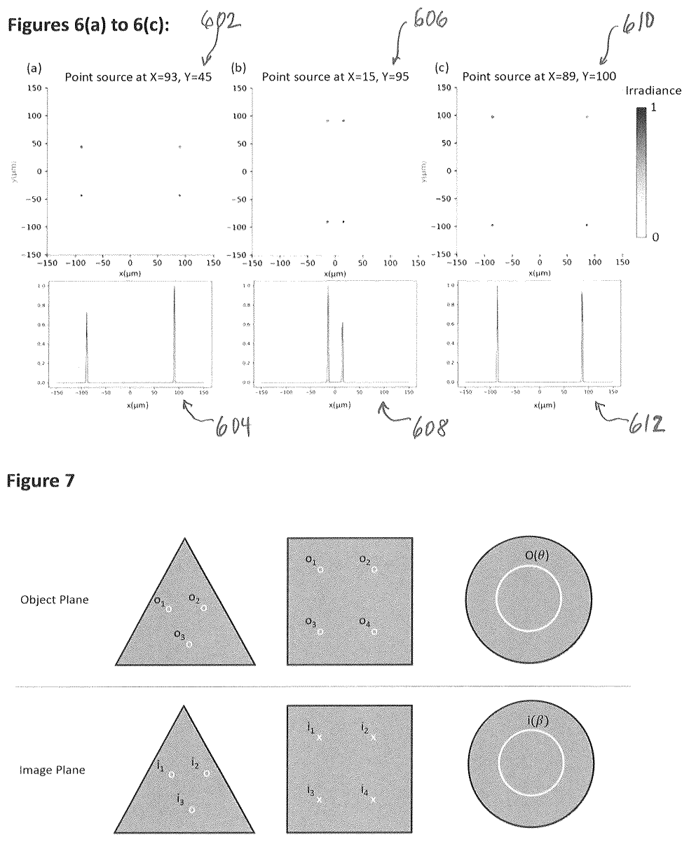

FIGS. 6(a) to 6(c) illustrate detectable points (also referred to herein as conjugate points) at the back end of the optical system. FIGS. 6(a) to 6(c) show how locating a point source of light at different locations in the object plane at the front end of the lens-waveguide-lens arrangement changes the locations and intensity of its detectable conjugate points in the image plane. The upper images show the irradiance distribution at the image plane. The lower plots illustrate the intensity profile of a horizontal line that passes through the maximum conjugate point(s) in each of the upper images.

As shown in FIG. 7, an object in the object plane (at the front end of the optical system) having three point sources of light o₁, o₂, o₃ that are transmitted through a triangular cross-section multimode waveguide may result in three detectable conjugate points i₁, i₂, i₃, in the image plane. Similarly, an object in the object plane having four point sources of light o₁, o₂, o₃, o₄ that are transmitted through a square cross-section multimode waveguide may result in four detectable conjugate points i₁, i₂, i₃, i₄ in the image plane. In a case using a circular-cross section multimode waveguide, an object o(θ) in the object plane may result in a circular image i(β) in the image plane. Depending on the configuration of the optical system described herein, it is understood that the object (in the object plane) and the resulting detected image (in the image plane) may be on the same side of the lens-waveguide-lens arrangement, on both sides of the lens-waveguide-lens arrangement, or on different sides of the of the lens-waveguide-lens arrangement.

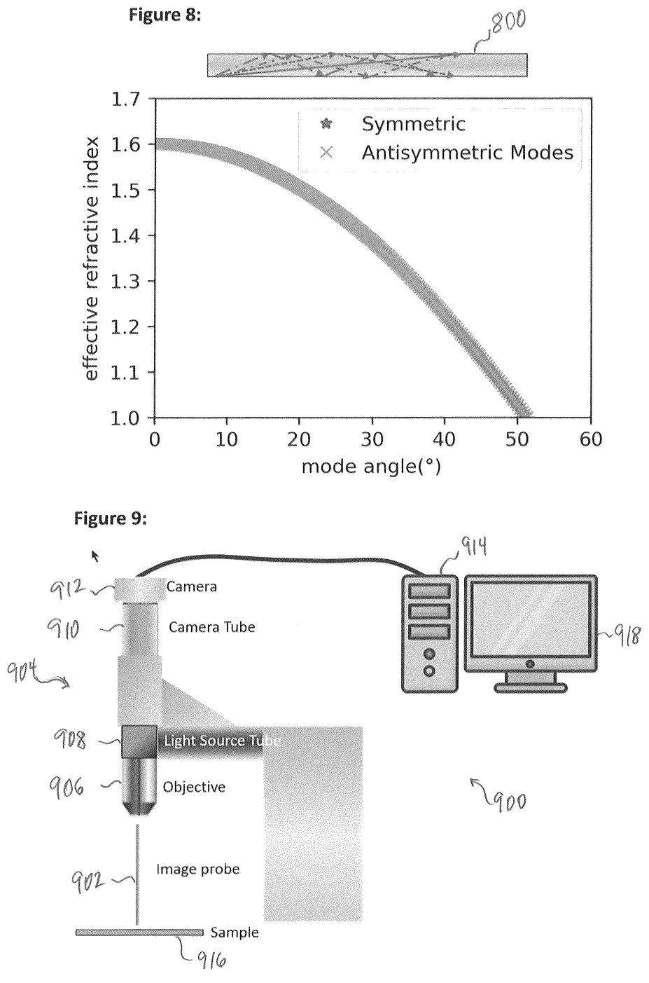

FIG. 8 illustrates different optical modes of a multimode waveguide 800, where each optical mode has a different light propagation angle. The number of modes propagating in the waveguide 800 is determined by the number of different angles that to which parallel rays (collimated light) produced by the front-end lens 102 are be coupled to the waveguide 800. The number of modes and the spacing between their propagation angles (the angle that rays hit the wall of the waveguide) is one factor that determines the overall resolution of the optical system. Another factor determining the overall resolution of the optical system is the resolution of the front-end lens 102 and the back-end lens 108. The graph in FIG. 8 shows asymmetric modes superimposed on symmetric modes of the system as the effective refractive index of the multimode waveguide varies with respect to the mode angle.

FIG. 9 depicts an example environment 900 in which inventive features of the present disclosure may be implemented. In FIG. 9, an image probe 902 is optically coupled to a microscope system 904 including an objective 906, a light source tube 908, and a camera tube 910. The camera tube 910 is optically coupled to a camera 912 having optical detectors that output data signals to a processing system of a computer 914. The data signals from the camera 912 represent an image captured by the camera 912 based on light received from the sample 916 by the image probe 902. In this configuration, it is contemplated that the image probe 902 includes the lens-waveguide-lens arrangement of the present disclosure and is optically coupled to the microscope system 904 to deliver light from the object being imaged, e.g., in the sample 916.

The processing system of the computer 914 is comprised of one or more processors that are configured to receive the data signals from the microscope camera 912 and use a transfer function as described herein to convert the data signals to an output image that more accurately represents the object in the sample being imaged. The output image which may be displayed on a display 918 of the computer 914.

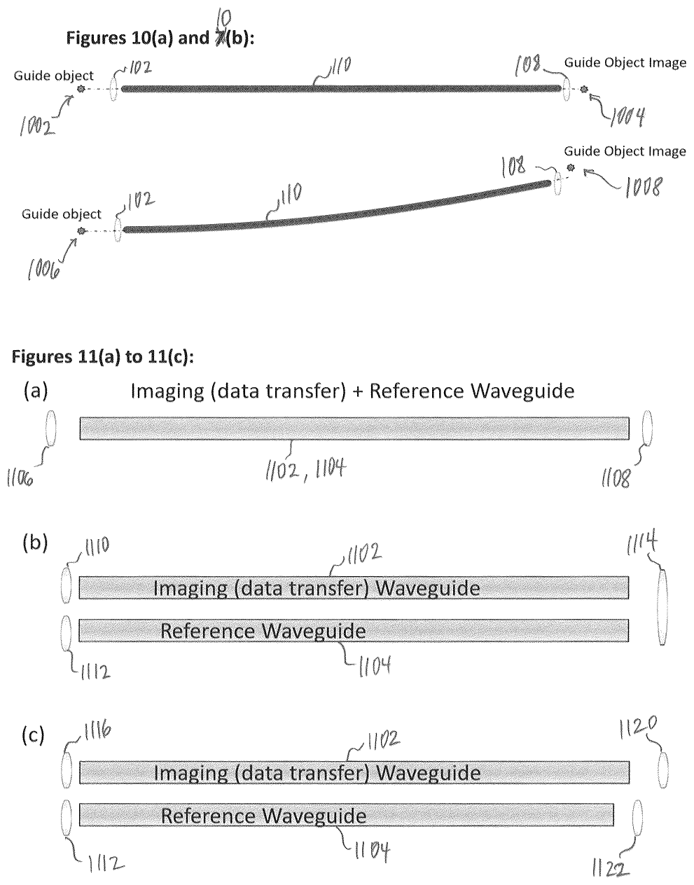

In FIGS. 10(a) and 10(b), a predetermined guide object 1002, such as a star-shaped image or object (referred to herein as a “star guide”), may be positioned in a predetermined location at the front end of the lens-waveguide-lens arrangement. Based on the guide object image 1004 at the back end (including location and intensity of the detectable point(s) in the back-end image plane), a transfer function representing the transfer of light from the front end to the back end may be computed. If the multimode waveguide 110 is subsequently bent (intentionally or unintentionally), the transfer function may be recomputed (or recalibrated) based on the current conditions of the multimode waveguide and the guide object image produced at the back end.

In particular, FIG. 10(a) illustrates the transfer of light from a guide object 1002 at the front end approximately inline with the propagation axis of a straight waveguide 110 to produce a guide object image 1004 approximately inline with the propagation axis at the back end.

FIG. 10(b) illustrates conditions where the waveguide is curved or bent. As with FIG. 10(a), the guide object 1004 at the front end is approximately inline with the propagation axis of the waveguide at the input to the waveguide. However, as a result of a curvature of the waveguide 110, the lens-multimode waveguide-lens arrangement as shown may output a guide object image 1006 at the back end that is located off the axis of the waveguide 110. Given a predetermined (known) object image input 1002, 1006 and the resulting observed image output 1004, 1008, a transfer function for the lens-multimode waveguide-lens arrangement may be recomputed or recalibrated as conditions change.

FIGS. 11(a) to 11(c) demonstrates that a variety of configurations can be used when implementing a reference waveguide and an imaging/data transfer waveguide as discussed herein. In FIG. 11(a), the imaging/data transfer waveguide 1102 and the reference waveguide 1104 are implemented using the same waveguide and the same front-end lens 1106 and back-end lens 1108.

In FIG. 11(b), the imaging/data transfer waveguide 1102 and the reference waveguide 1104 are implemented using different waveguides. Moreover, while the imaging/data transfer waveguide 1102 and the reference waveguide 1104 are shown using different front-end lenses 1110, 1112, they share a common back-end lens 1114.

In FIG. 11(c), the imaging/data transfer waveguide 1102 and the reference waveguide 1104 are implemented using different waveguides of different length. In this example, the imaging/data transfer waveguide 1102 and the reference waveguide 1104 are shown using different front-end lenses 1116, 1118 and different back-end lenses 1120, 1122, though that is not required.

It should be understood that a wide variety of configurations, including configurations not depicted here, can be provided for imaging and data transfer using the principles of the present disclosure. In some cases, the reference waveguide may be part of the multimode waveguide used for imaging or data transfer. In other cases, the reference waveguide is a separate waveguide. Data from the reference waveguide is usable to update the transfer function. For example, adding a reference waveguide (separate or the same as the imaging waveguide) may be used to adjust or update the transfer function according to environmental changes in the imaging multimode waveguide.

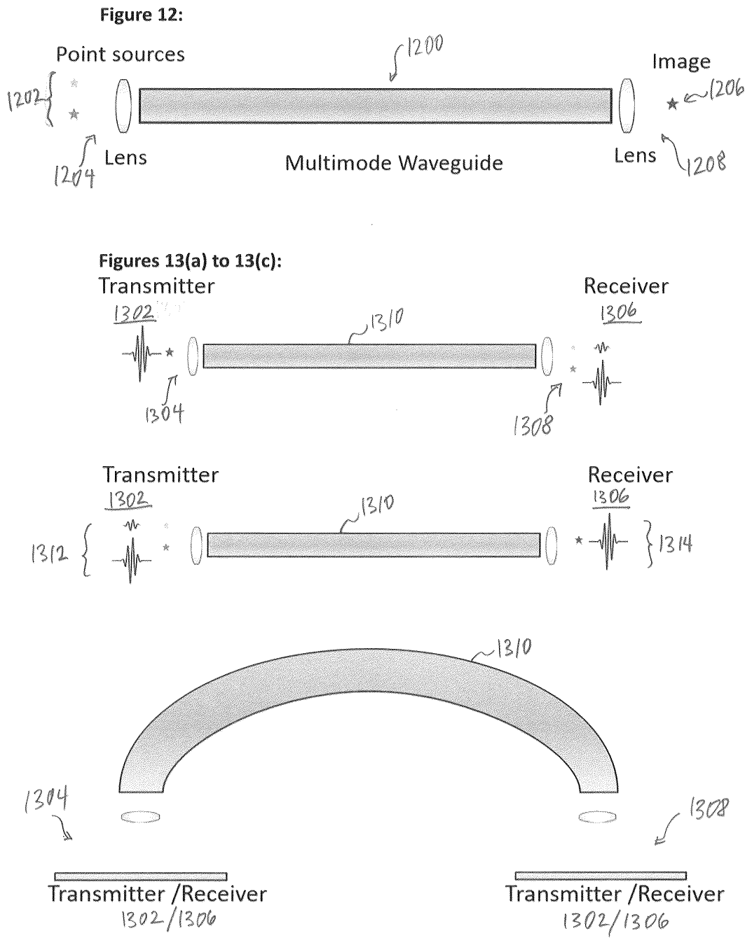

FIG. 12 illustrates an example 1200 in which the lens-multimode waveguide-lens arrangement is utilized to generate an image or pattern 1202 at the front end 1204 from a pattern or image 1206 provided at the back end 1208. As mentioned earlier herein, embodiments of the lens-waveguide-lens arrangement may be configured to transfer of light in either direction, from the front end 1204 to the back end 1208, or from the back end 1208 to the front end 1202. In the example shown in FIG. 12, the optical system is arranged to generate an image or pattern 1202 at the front end 1204 based on an image or pattern 1206 provided at the back end 1208.

FIG. 13(a) shows an optical data communication link 1300 using a lens-multimode waveguide-lens arrangement as described herein with a multi-channel optical transmitter 1302 at the front end 1304 and receiver 1306 at the back end 1308. Any type of optical or opto-electronic transmitter 1302 and receiver 1306 can be used at the front end 1304 and back end 1308. Using this configuration, light from each channel of the transmitter 1302 can be coupled into one mode of the multimode waveguide 1310. On the receiver side, the receiver 1306 receives the light from the transmitter 1302 at a few detectable points (using a few receivers or detectors). Since the number of communication channels can be increased based on the number of modes utilized in the multimode waveguide 1310, the features of the present disclosure significantly increase the number of data channels that can be deployed for the transmitter 1302 and receiver(s) 1306. The inventive arrangement herein significantly decreases the complexity of the communication link by transmitting each data channel on a separate mode of the multimode waveguide 1310.

FIG. 13(b) shows a modification of the optical input 1312 provided by the transmitter 1302 to produce isolated pulse data 1314 at a single detectable point received by the receiver 1306. In some examples, the number of points on the receiving side can be decreased by using multiple transmitters or multiple transmitter points as shown.

FIG. 13(c) shows an example of the lens-multimode waveguide-lens arrangement with a transmitter 1302 and receiver 1304 on both ends of the waveguide 1310 providing the communication link, i.e., on the front end 1304 and the back end 1308 of the waveguide. In cases where the multimode waveguide 1310 is bent, e.g., as shown, the transmitter/receiver arrangement at each end are usable to recalibrate the transfer function (or transmission matrix) according to the current conditions of the waveguide 1310.

FIG. 14(a) illustrates an example in which the front-end lens 1402 of a lens-multimode waveguide-lens arrangement 1400 is arranged to a side of the multimode waveguide 1410. A mirror 1404 is arranged in the light path from the front-end lens 1420 to redirect light from the front-end lens 1402 into a mode of the multimode waveguide 1410 for transmission through the waveguide 1410 to the back-end lens 1406 shown inline with the multimode waveguide 1410.

FIG. 14(b) illustrates another example in which multiple front-end lenses 1408 are arranged to the side the multimode waveguide 1410. Mirrors 1412 are arranged in respective light paths of the light from the multiple front-end lenses 1408. In this example, the mirrors 1412 are partially reflective or transmissive in the same or in different light wavelength bands.

FIG. 14(c) shows that light from different locations can be coupled at different angles and utilize different modes of the multimode waveguide 1410 to transfer light, e.g., from different depths of an object being imaged. One realization of such a system is to embed mirrors 1416, 1418, 1420, 1422 in different angles along the multimode waveguide 1410 or change the angle of the light from the front-end lenses 1414 before coupling the light into the waveguide 1410 in the front-end of the system. FIG. 14(c) also illustrates that different size lenses, such as the back-end lens 1423, may be used, e.g., to accommodate a wider or narrower range of angles that light may be received from the multimode waveguide 1410.

FIG. 14(d) illustrates a configuration in which different illumination waveguides 1428, 1434, 1440, 1446 are used for illumination of parts of the object in front of each front-end lens 1424, 1430, 1436, 1442 on the side of the multimode waveguide 1410. The illumination waveguides 1428, 1434, 1440, 1446 can be on the same substrate or different substrates from the multimode waveguide 1410. Distribution of the light in the illuminating waveguides (i.e., transferring light through them or not transferring light through them) can be achieved through any on-chip or off-chip mechanism. Accordingly, light can be excited at desired depths of an object being imaged and collected by the lens-multimode waveguide-lens arrangement of the present disclosure. Light received from the multimode waveguide in this case is focused by the back-end lens 1448.

Using multiple waveguides for illuminating different depths can decrease the complexity of the probe's design and the back-end system for reconstructing images. For example, light can be switched on in one of the illumination waveguides 1428, 1434, 1440, 1446, and the image from the lens in front of the illumination waveguide with light can be captured. The illuminating light and waveguide can be on-chip or off-chip. The illumination waveguide can be on the same substrate as the lens-waveguide-lens system or on a different substrate. The illumination waveguides can have variety of light switching mechanisms to guide light on a selective basis to each illumination waveguide. They can have any mechanism to couple light out of the illuminating waveguides such as grating couplers, edge couplers, bare waveguides, etc. Light from the illumination waveguides can be mixed by an arrangement such as presented in FIG. 14(c).

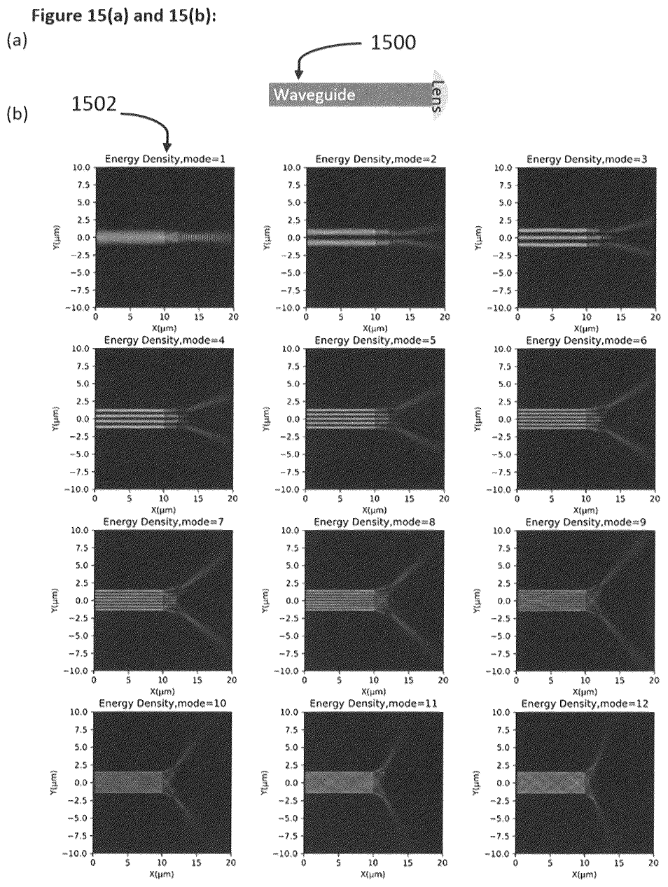

FIG. 15(a) is a schematic view of a multimode waveguide and a lens that are simulated. FIG. 15(b) illustrates several plots depicting the energy density of a multimode waveguide-lens system simulated using a finite difference time domain simulation. As can be seen, as the mode number and the propagation angle in the waveguide (angle of the light rays in the waveguide) increases, the distance of the image points becomes further away from the main axis. Here in this example, it is seen that for specific waveguide and excitation conditions, there are two image points for each mode (other than mode 1). Using an aberration corrected lens, the efficiency and quality of the image points at the receiving side can be significantly increased.

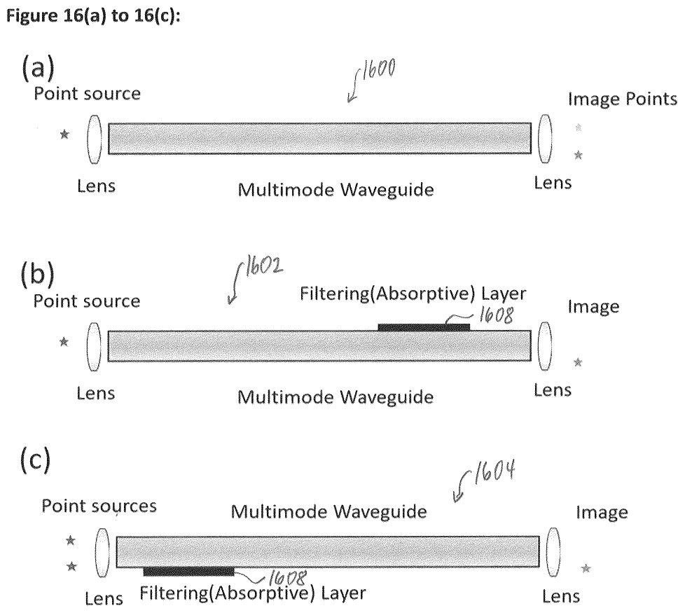

FIGS. 16(a) to 16(c) show that, in addition to using an aperture in the light path, different filtering methods such as adding, removing, and patterning absorptive/nonabsorptive material on the multimode waveguide can be applied to remove unwanted or unnecessary secondary image points, thus removing part of image produces from imaging the object in the object plane. Patterning of an absorptive material on the waveguide may produce results similar to using an aperture in the lens system.

More specifically, FIG. 16(a) depicts the lens-multimode waveguide-lens system 1600 without a filtering layer. FIG. 16(b) shows a system 1602 in which a patterned absorptive layer 1604 is added closer to the image side at the back end of the waveguide, which removes a secondary image at the back-end image plane (compare to FIG. 16(a)). FIG. 16(c) shows a system 1606 in which adding a patterned filtering layer 1608 closer to the object plane at the front-end filters or removes part of the light (point sources) at the front-end object plane.

The following description provides additional details regarding the operation of a transfer matrix to reconstruct an object image from light at detected conjugate points at the back end image plane of the optical system.

For a waveguide cross-section with m number of sides, there generally will be m points on the object plane and m points on the image plane that their light intensities are related (assuming the lenses focus two adjacent modes of the waveguide at points that their distance is larger than the resolution of the lens system). For example, for a square waveguide, light from a point source (O₁) at the object plane will only appear at i₁,i₀,i₃, and i₄ (see FIG. 7). This significantly simplifies the transfer matrix and reduces the number of non-zero points on each column of the transfer matrix to m, substantially decreasing the computational resources required to convert the output image at the image plane to the actual object image. Decoupling the image points from all of the pixels on the image sensor at the back end to only m points on the image sensor means only solving N/m decoupled sets of m equations instead of N-coupled equations. This can significantly increase the speed and robustness of solving the equations used when implementing the transfer matrix. For example, 2500 sets of four equations with four unknowns is far more manageable and less computationally intensive than solving 10000 equations with 10000 unknowns.

The decoupled sets can be written as follows:

$$[ \begin{matrix}{i}_{1} \\ ⋮ \\ {i}_{m}\end{matrix} ] = [ \begin{matrix}{c}_{11} & … & {c}_{1 m} \\ ⋮ & ⋱ & ⋮ \\ {c}_{1 m} & … & {c}_{mm}\end{matrix} ] [ \begin{matrix}{o}_{1} \\ ⋮ \\ {o}_{m}\end{matrix} ]$$

The inverse of the above matrix can be calculated (simple mathematical inverse) or measured (reverse the calibration method by swapping the image and object plane location during the calibration) as follows:

$$[ \begin{matrix}{o}_{1} \\ ⋮ \\ {o}_{m}\end{matrix} ] = [ \begin{matrix}{b}_{11} & … & {b}_{1 m} \\ ⋮ & ⋱ & ⋮ \\ {b}_{1 m} & … & {b}_{mm}\end{matrix} ] [ \begin{matrix}{i}_{1} \\ ⋮ \\ {i}_{m}\end{matrix} ]$$

In some cases, m points on the object plane have k points on the image plane in which m and k are not equal. This can occur due to the imperfect light path, such as a bend in the waveguide, rounded corners, etc.

$$[ \begin{matrix}{i}_{1} \\ ⋮ \\ {i}_{k}\end{matrix} ] = [ \begin{matrix}{c}_{11} & … & {c}_{1 m} \\ ⋮ & ⋱ & ⋮ \\ {c}_{k 1} & … & {c}_{km}\end{matrix} ] [ \begin{matrix}{o}_{1} \\ ⋮ \\ {o}_{m}\end{matrix} ]$$

In some cases, m is not equal to the number of sides of the waveguide. This can occur due to the imperfect light path, such as bending in the waveguide, rounded corners, etc. In any event, the foregoing equations can be used to construct the transfer matrix (T) that enables reconstruction of the image of the object (or data being transferred) at the back end of the optical system.

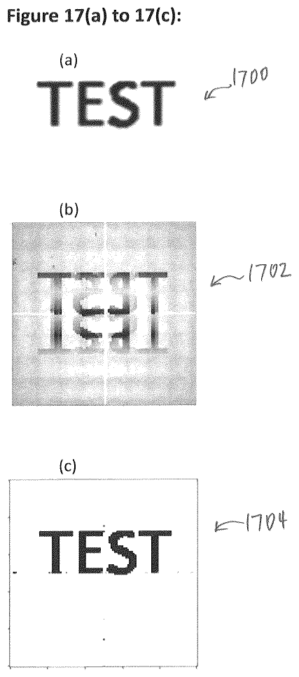

FIGS. 17(a) to 17(c) illustrate an example of an input and output of an optical system constructed and operated according to principles of the invention described herein. FIG. 17(a) shows a TEST object 1700 at the front-end object plane. After the light from the object plane has been transmitted through a lens-square waveguide-lens system, FIG. 17(b) shows the pseudo-image 1702 that is received at the back end by the image sensor at the image plane. FIG. 17(c) shows a reconstructed image 1704 of the object after the transfer matrix T has been applied to the pseudo image. As can be seen, the optical system in this disclosure enables fast and accurate reconstruction of the image (or data) that is transmitted through the system. Suitable mathematical methods are used to construct the transfer matrix T during the test and calibration operations described herein.

For the case of waveguides having a cross-section with near-infinite or infinite sides (such as a circular cross-section waveguide), the discrete equations above can be modified to a continuous form, such as the following integral form:

i(r,β)=∫_{θ}_{₀}^{θ}^{₁}c(θ,r,β)o(θ,r)dθ

where r and β are the radius and angle of the point on the image plane, θ is the angle of the point on the object plane. For simplification, the radius r (in polar coordinate) of the image and object conjugates are considered to be the same.

For more general cases, the above equation is updated to the path integral over the whole path of the object plane to image plane conjugate points:

i(ρ₀)=∫^{Conjugate path}c(ρ₀,ρ)o(ρ₀,ρ)dρ

where ρ₀ is the point on the conjugate path (potentially a closed loop) in the image plane. ρ is a point on the conjugate path on the object plane (potentially on a closed loop).

For more general cases, the above integral can be written:

i(x₀,y₀)=∫∫^{Conjugate Area}c(x,y,x₀,y₀)o(x,y)dxdy

where (x₀, y₀) is the point on the conjugate area in the image plane. (x, y) is a point on the conjugate area on the object plane. In the above equations, the object and image planes are interchangeable, that is the conjugate path and relationship between points on the object plane and points on the image plane are bidirectional.

FIGS. 18(a) to 18(c) are instructive as they show the results that occur when the principles of the present disclosure are not employed. The TEST object 1800 in FIG. 18(a) is positioned on the front end of the multimode waveguide 1810 shown in FIG. 18(b). Thereafter, FIG. 18(c) shows the pattern 1802 that is output from the back end of the waveguide 1810 after the light emitted or reflected by the test object 1800 passes through the waveguide 1810. Without using a front-end lens and a back-end lens as described herein, the waveguide 1810 outputs the patten 1802 that appears to the observer as distorted and confusing and does not resemble the test object 1800.

A comparison of the output pattern 1802 in FIG. 18(c) (using a system that does not implement the present disclosure) with the pseudo-image 1702 in FIG. 17(b) (using a system that does implement the present disclosure, including a lens on each end of the waveguide) shows that embodiments of the present disclosure greatly improve the image output and make it easier for the transfer matrix T to compute the final image. Comparing the output pattern 1802 in FIG. 18(c) to the pseudo-image 1702 in FIG. 17(b) also demonstrates how the present disclosure improves the image contrast (signal-to-noise ratio, SNR).

An improved SNR is obtained using the lens-waveguide-lens system of the present disclosure, instead of only a multimode waveguide alone. In the latter case, when a point source is in front of a multimode waveguide alone, its light signal is distributed across the whole image plane. In this case, the minimum recognizable signal will be ˜N×Noise, where N is the number of pixels on the back-end sensor and Noise is the Noise level of the sensor. On the other hand, when a point source is in front of the lens-waveguide-lens system, the light from the point source will be focused on m points, based on the number of sides of the waveguide. This means the minimum recognizable signal will be ˜m×Noise. For example, for the lens-rectangular waveguide-lens system with 100×100 modes, the SNR of the lens-waveguide-lens system will be 2500 times higher than only the multimode waveguide.

Decreasing the number of sides of the multimode waveguide will increase the SNR. As mentioned above, the SNR will be

$$\frac{Signal}{m \times sensor pixel noise}$$

so decreasing the number of sides (m) will increase the SNR.

Additionally, decreasing waveguide imperfections to increase the SNR. Decreasing the waveguide imperfections, such as a bend in the waveguide or round corners, will reduce the number of conjugate points in the back-end image plane that will increase the SNR.

The output of the lens-waveguide-lens system can change as environmental changes occur in the light path, mostly due to changes in the waveguide. By sending light with a specific (calibration) pattern, such as a single point source on one end of the waveguide and imaging/measuring the output light pattern at the other end (or the same end, for the case where a reflection back of some or all of the light that has been transferred through the waveguide), the environmental change can be identified and the transfer function can be updated.

For example, adding a reference waveguide to the optical system may be advantageous. See, e.g., FIGS. 11(a) to 11(c). Using two (or more) lens-waveguide-lens systems, one of the waveguides is used for imaging or data transfer. The other waveguide is used as a reference to identify the changes in the transfer function. It is noted that in some cases, the same waveguide can be used both as the reference and for the image and data transfer, thought the implementation of such is a bit more complicated. In some cases, the waveguides can switch roles and be used as the reference or for imaging/data transfer. In some cases, they can each be used partially for each purpose.

The reference lens-waveguide-lens can be used to identify both environmental and non-environmental changes in the optical system. These changes can be, for example, changes in the curvature of the waveguide, refractive index, change in the length of the waveguide, variation of the waveguide shape (waveguide corners), change in temperature, humidity, pressure, strain, etc.

The pseudo-image that is output from the lens-waveguide-lens reference line can change as the environmental changes occur in the light path (mostly waveguide). By transmitting light with a specific pattern (e.g., single point source) on one end and imaging/measuring the light at the other end (or the same end, for cases of reflection), changes in the optical system can be identified and the transfer function can be updated.

To identify the changes in the light path using the output pattern or pseudo-image of the reference line, the light can be transmitted anywhere along the light path and imaged or measured at anywhere in the light path. For example, in one of the simplest implementations, a single point source (dot point) can be sent through the front-end lens of the optical system into the waveguide, and the light can be partially reflected from the distal end. The output pattern can then be measured/imaged at the front end.

The pattern of the light that is transmitted through the waveguide and the pattern of the feedback creator (in some cases, a partial reflector) can be in any shape. For example, this pattern can vary from a small dot to a full circular/rectangular shape.

The feedback wavelength can be different from the light used to create it. For example, fluorescence or nonlinear light can be used in the feedback. Furthermore, the feedback signal can be modulated at a frequency different from the transmitted signal in order to detect changes. Light transmitted via the reference line and the image/data transfer line can have different wavelengths or the same wavelength.

To increase, decrease, or suppress the effect of environmental changes on the output of the optical system, the light transmitted through the system can be bounced back and forth between a part of the waveguide or the whole waveguide. The bouncing can be realized by using partial or full reflector mirrors (acting as an optical resonator) in the light path or by using optical loops (fiber/waveguide loops).

In some cases, the same waveguide can be used as a reference and for image/data transfer. In such cases, all of the above-mentioned configurations for implementation of the reference can be accomplished using the same lens-waveguide-lens system. An object for imaging can also be used as a calibration or feedback pattern.

In calibration, there are several ways to obtain the transfer matrix T used to convert the output pseudo-image (what the image sensor sees) to the final output image. One way is to simulate the lens-waveguide-lens system on a computer and determine the transfer function and potentially its inverse. Another way is to use one or multiple known point sources on the object plane to find the transfer function. This may involve directly using a transfer function to solve the equations that relate the pseudo-image to the true image of the object. Alternatively, this may use an inverse of the transfer function and multiply the pseudo-image (vector or matrix) with the inverse matrix to convert the pseudo-image to the true image. In some cases, to find the inverse of the transfer function directly, it is possible to use one or multiple (known) point sources on the back-end image plane and an optical sensor on the front-end object plane. Another way is to use a symmetric system that has a similar optical configuration of the object-lens-waveguide-lens-image and image-lens-waveguide-lens-object to achieve T=T⁻¹ (involuntary transfer matrix). Yet another way is to use a system with similar optical configuration of the object-lens-waveguide-lens-image and image-lens-waveguide-lens-object with only magnification on the object or image side, which simplifies the transfer function.

The back-end system can be, for example, any microscopy system including bright field or laser scanning microscopy, such as two photons and confocal microscopy. For laser scanning microscopy (LSM), the LSM (at the image plane) focuses light on at least one of the back-end pixels. Light propagates through the lens-waveguide-lens system and is distributed on all m conjugate points of the back-end pixel on the front-end object side. When the light from the object side returns to the back-end, the LSM records information detected from that light, e.g., at the pixel. As the LSM records information from the detected light, the image can be reconstructed in the same way as bright field imaging using a transfer function as described herein. Other types or configurations of the LSM can be also applied at the back-end such as a spinning disk, using the a microelectromechanical mirror or a digital micromirror device (DMD), etc. to increase the scanning and image recording speed.

In some cases, DMD or a spatial light modulator (SLM) is used at the back end or front end of the lens-waveguide-lens system to control the phase, intensity, and polarization of the light.

In some cases, it is possible to change the focal plane of the lenses to change the image plane and the object plane. Such changes can be done by movement of the lens or lenses in the lens-waveguide-lens system, or it can be done by changing the focal plane of the lenses in the back end or the front end using the tunable lenses. Changes in the focal plane can also be realized using different wavelengths.

The following description outlines additional, different configurations that may be implemented according to the present disclosure.

In the lens-waveguide-lens system, the lenses or a series of lenses can be attached to the waveguide or attached to different other systems. In some cases, lenses may be used on only one end of the waveguide, and the other end may have no lens. This may be utilized in cases such as images from far fields (where the object located essentially in infinity). It can also be utilized when, at one end of the waveguide, a back-end/front-end system directly couples different modes to the waveguide (exciting different mode profiles), and at the other end, a lens is used to focus that mode at the conjugate points.

Waveguides can be on-chip single/multimode waveguides or any other type such as multimode or single-mode optical fibers. Any form of waveguide such as hollow-core waveguide or fiber can be used. In some cases, fully or partially reflective material (e.g. mirror) can be used on the whole or part of the wall of a tube or core to achieve the light guiding effect of the waveguide as discussed above. As long as the waveguide mode has a similar pattern/profile to a waveguide with m-sides, all of the above-mentioned techniques can be utilized. In such cases, the mode-shape (profile) is significant and more important than the physical cross-section of the waveguide. For example, to realize a system similar to a triangular or rectangular waveguide, it is possible to combine a few different materials with different shapes to achieve the same mode characteristics as a waveguide with a rectangular or triangular cross-section.

For example, FIGS. 19(a) and 19(b) illustrate different configurations for the guiding of light in different ways. As shown in FIG. 19(a), a waveguide 1900 (shown in cross-section) may have special shapes of the core and cladding, or in FIG. 19(b), the waveguide 1902 may have a hollow core.

Furthermore, the detector at the receiving end (e.g., the back end) of the optical system may employ any combination of optical, optoelectronics, or electronic components. Similarly, at the front end, a transmitter may employ any combination of optical, optoelectronics, or electronic components.

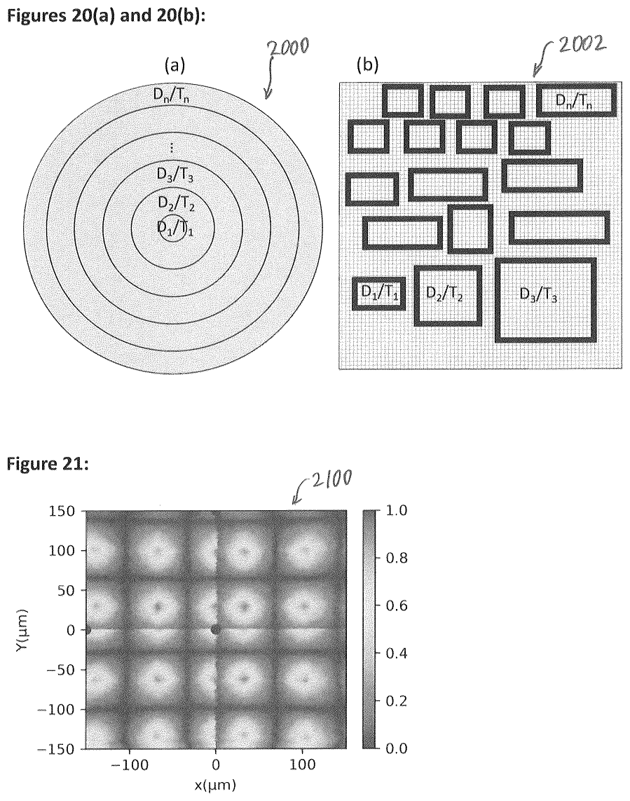

The shapes, location and profile of the conjugate points on the object and image planes may vary due to changes in the waveguide or lens(es) used. The shape or configuration of the detector or transmitter can be manufactured or realized virtually (post-processing) to compensate for the shape of the conjugate patterns due to effects such as the waveguide bend, rounded corners, rounded waveguide, etc. See, e.g., FIGS. 20(a) and 20(b). FIG. 20(a) provides an example 2000 of how the design and manufacturing of suitable detectors or transmitters may be based on the shape of the conjugate pattern's profile or other important parameters. FIG. 20(b) illustrates a virtual realization 2002 of different forms of detectors or transmitters based on the shape of the conjugate patterns or other important parameters.

In any case, for multiplexing of signals and increasing data throughput, light can be modulated in different frequencies at the transmitter side for data transfer applications to provide an additional realization (coding/decoding) on the detector side. For example, in cases having an m-sided waveguide, m-conjugate points at the transmitter side can each be modulated at different frequencies. On the detector side, after converting the light signal to electrical signal, each of m frequencies can be separated using electronic filters. The signals with the i^{th} modulated frequency of all m conjugates on the detector side can be summed, or the largest can be picked, or can be used for redundancy. Different optical, photonic, optoelectronic, and electronic combinations can be used to realize this configuration on the transmitter and/or detector side.

In some cases, different wavelengths of light can be used at the transmitter side to provide an additional realization (coding/decoding) on the detector side. For example, in cases having an m-sided waveguide, different wavelengths or frequencies of light can be used at each of the m conjugate points at the transmitter side. On the detector side, using different photonic, optical, or optoelectronic filters, each of the m wavelengths can be separated. The signals with the i^{th} wavelength of all m conjugates on the detector side can be summed, or the largest can be picked or used for redundancy. Different optical, photonic, optoelectronic, and electronic combinations can be used to realize this configuration on the transmitter and detector side.

In some cases, different polarizations of light can be used on the transmitter side to provide additional realization (coding/decoding) on the detector side. For example, in cases having an m-sided waveguide, different polarizations of light can be used at each of the m-conjugate points at the transmitter side. On the detector side, using different photonic, optical, or optoelectronic filters, each of m polarizations can be separated. The signals with the i^{th} polarization of all m conjugates on the detector side can be summed, or the largest can be picked or used for redundancy. Different optical, photonic, optoelectronic, phase mask, SLM, DMD, and electronic combinations can be used to realize this configuration on the transmitter and detector side.

In yet further configurations employing quantum mechanics, the lens-waveguide-lens arrangement described herein can be used to introduce the interaction of single or multiple photons with each other. The conjugate points on the transmission side and the detector sides can be used for the interaction of the photons with different quantum states with different coefficients.

For example, the optical system herein can be implemented as a linear optical quantum computing system. The photon sources (for example, a single photon quantum source) are located in the object plane. Each photon source (input for the quantum computing) excites one mode or multiple modes of the multimode waveguide. In the multimode waveguide, two or multiple modes which are corresponding to two or multiple photons with the same or different quantum states interact (interfere) and are mixed with each other. The interaction between the modes can be increased by adding geometrical or material features or intentional imperfections in the waveguide. Some features can be features from bending the waveguide, adding grating to the waveguide, adding some material/geometrical variation to the middle or a corner of the waveguide, etc. The interactions between the photons (modes) creates new quantum states (i.e., superposition states). At the other end of the waveguide, a lens as described herein will image/focus photons based on their mode number, quantum states and their interactions with other modes at different points. The photonic circuits, optical elements, optoelectronic circuits or any other type of detectors can be used to detect and process these interactions and superposed states (i.e., output for the quantum computer). A cascade of the lens-waveguide-lens system described herein can be used to create further interactions and superposed modes. The lens-waveguide-lens is advantageous for creating and detecting superposed states because of the significant increase in the SNR of the optical system herein compared to conventional systems using only a multimode waveguide without lenses.

As to performing mathematic computations using the lens-waveguide-lens arrangement, it has been found that interactions between conjugate points can be used to perform mathematical calculations at essentially the speed of light. For example, at the transmitter side, each of the conjugate points can be modulated at different frequencies (f₁, f₂, . . . , fₘ) (or having different wavelengths). On the detector side, a summation of the intensity of light can be used to find the sum of the intensity of the conjugate points. For example. A multiplication of the conjugate points' electric field (E₁, E₂, . . . , Eₘ) can be found at different frequencies at the detector side. For example, the multiplication of EᵢEⱼ can be found at the frequency of fᵢ-fⱼ and fⱼ-fᵢ. As another example, matrix multiplication can be realized using the (transfer) matrix relationship between the conjugate points:

$$[ \begin{matrix}{i}_{1} \\ ⋮ \\ {i}_{m}\end{matrix} ] = [ \begin{matrix}{c}_{11} & … & {c}_{1 m} \\ ⋮ & ⋱ & ⋮ \\ {c}_{1 m} & … & {c}_{mm}\end{matrix} ] [ \begin{matrix}{o}_{1} \\ ⋮ \\ {o}_{m}\end{matrix} ] .$$

By moving from one set of the conjugate points to another set (e.g., changing location (x,y) of transmitters (conjugate points) in the transmitter plane), the above C matrix can be changed. A variety of values in the C matrix can be achieved. Changing some of the other parameters, such as changing the effective length of the waveguide, can also change the coefficients in the C matrix.

FIG. 21 is a graphic image 2100 that depicts how a change of the transmitter location (i.e., a point source on the object plane with an intensity of 1, for example) changes the values of its conjugate points in the image plane. The values of the conjugate points at each quadrant correspond to the first column of the C matrix.

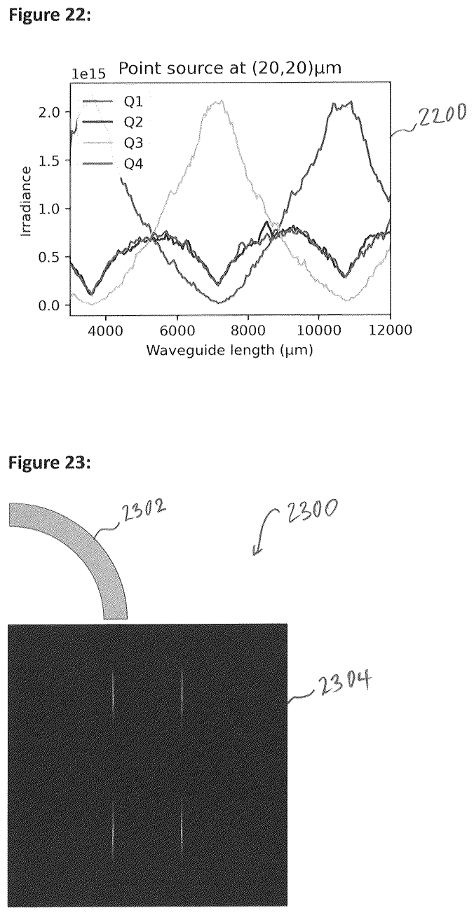

All of the points discussed above regarding use of a reference line to correct for the transmission signal can also be used to sense environmental effects and changes in the optical system. For example, FIG. 22 is a graph 2200 that illustrates the effect of changes of the waveguide length (light path) on the amount of power received at conjugate points in each quadrant of the image plane. A change of length of the waveguide may be introduced by changing its physical or geometrical length, changing its refractive index, changing the temperature, strain, or stress of the waveguide, etc.

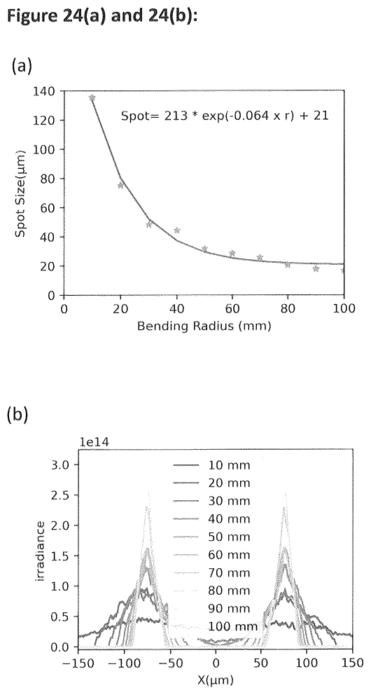

FIG. 23 is a graphic depiction 2300 of the effect of the bending radius of a waveguide on the image plane spot size. In this example, the waveguide 2302 has been bent in one direction. In the image plane 2304, the conjugate points are spread in one direction instead of having a circular point spread function. The spread is the same size as the point spread function of the lens system. The point spread functions of the conjugate points, spot size, and output irradiance may vary depending on the shape and curvature of the bend of the waveguide, as illustrated in FIGS. 24(a) and 24(b).

The waveguide 2300 can be bent in different ways to achieve smaller or larger point spread functions. Consequently, it is understood that the waveguide 2300 can be bent in different shapes and ways (changing waveguide longitudinal path) to achieve different transfer functions. Using different shapes of bending of the waveguide can increase or decrease the size of the point spread function. After bending the waveguide, the transfer function can be updated based on the new point spread functions of the conjugate points.

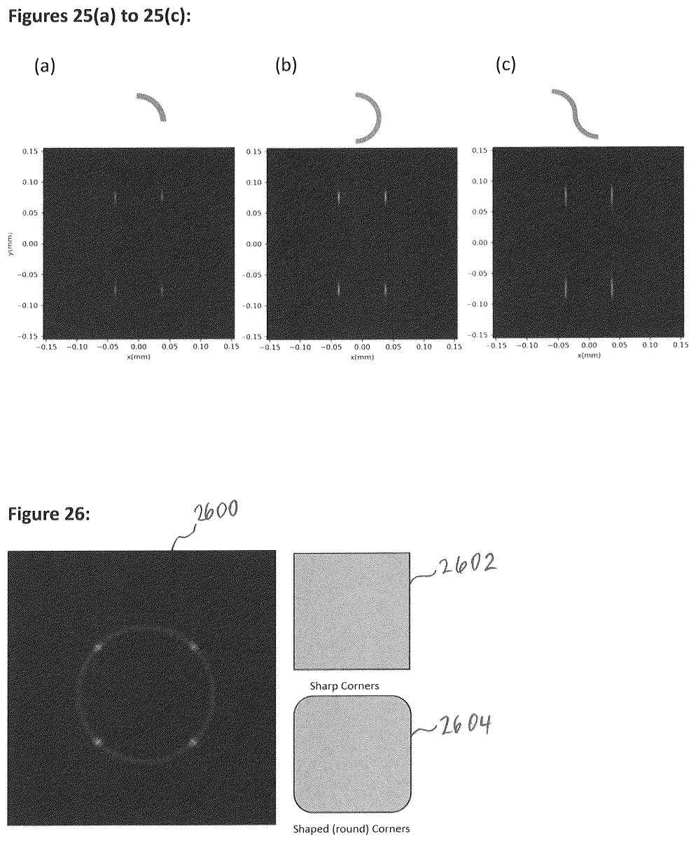

FIGS. 25(a) to 25(c) show the effect of different shapes of the waveguide (bend) on how the point spread function of the conjugate points varies in the image plane. For example, it is shown here how the width of the point spread function for this specific waveguide and the specific location of the point source is relatively similar for bends of 90° (FIG. 25(a)) and 180° (FIG. 25(b)) of the waveguide, and increases for the S-shape bend (FIG. 25(c)).

FIG. 26 is a graphic image 2600 showing the effect of shaped corners of the waveguide on the location and spreading of the light in the image plane. In this regard, the waveguide may be any shape, not limited to a circular cross-section. In the image 2600, instead of light being focused on four spots for a rectangular-shaped waveguide 2602, part of the light will spread around a circle that passes through the four points. Using this pattern observed in the graphic image at the image plane, the radius of round corners (or overall shape of the corners) of the waveguide can be identified and used in one or more mathematical functions to correct the effect of round corners 2604 of the waveguide on the image produced in the image plane. Moreover, the corners of the waveguide can be engineered to achieve a desired pattern at the image plane. In some cases, a shaped corner can be introduced by changing the refractive index of the corners and not necessarily changing the physical geometry of the corners.

Advantageously, as seen in the above detailed description, the present disclosure provides systems and methods that reconstruct transmitted images or data using a much transfer matrix comprised of m×m equations, where m is number of sides of the multimode waveguide. Furthermore, the signal-to-noise ratio is increased by decreasing the number of sides of the multimode waveguide.

The systems and method herein are able to sense and react to environmental changes by observing and adjusting to changes of the image pattern produced in the image plane. A reference line (using a separate waveguide or the same waveguide) may be used to correct for such environmental changes by updating the transfer matrix.

Different methods are provided for determining and updating the transfer matrix in one or more calibration operations. In some cases, the systems herein may use a laser scanning system in the back end. Different configurations, for the waveguide in particular, may be selected and implemented to achieve the desired performance. Detectors may be arranged virtually or in hardware using different shapes or array configurations, which can be very important for data transfer. For data transfer, systems and methods herein may multiplex the signals transmitted in various modes of the multimode waveguide and thereby increase the number of channels available for communication. The lens-multimode waveguide-lens arrangement may also be used for mathematical operations.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An optical system comprising:
a front-end lens configured to receive light from one or more point sources;
a multimode waveguide that is optically coupled to the front-end lens to receive light from the front-end lens, wherein the light received from the front-end lens is transmitted through the multimode waveguide in one or more modes of the multimode waveguide; and
a back-end lens configured to receive light that is output from the multimode waveguide, wherein the back-end lens directs the light to one or more detectable points.

2. The optical system of claim 1, wherein the front-end lens directs light from two or more point sources to the multimode waveguide at different angles relative to a propagation axis of the multimode waveguide such that the light from the two or more point sources is transmitted via two or more different modes, respectively, of the multimode waveguide.

3. The optical system of claim 1, wherein the multimode waveguide has a non-circular cross-section.

4. The optical system of claim 3, wherein the cross-section of the multimode waveguide has 2, 3, 4, 5, 6, 7, or 8 sides.

5. The optical system of claim 1, wherein light received by the front-end lens from a point source and transmitted through the multimode waveguide is directed by the back-end lens to the one or more detectable points.

6. The optical system of claim 1, further comprising:
a detector configured to detect light at the one or more detectable points and produce a detection signal; and
a processor configured to apply a transfer function to the detection signal to produce a system output comprising information that was transmitted in the light from the one or more point sources,
wherein the transfer function is determined for the one or more detectable points based on a condition of the multimode waveguide.

7. The optical system of claim 6, wherein the information transmitted in the light from the one or more point sources is an image or data communication, and
the transfer function is determined based on calibration performed using the multimode waveguide or from a computer simulation of the multimode waveguide.

8. The optical system of claim 6, wherein a reference waveguide is configured to receive and transmit light, and changes in light transmission via the reference waveguide is usable to determine the condition of the multimode waveguide.

9. The optical system of claim 6, further comprising an absorber arranged to selectively absorb at least a portion of the light received from the front-end lens or the light that is output to from the multimode waveguide, thereby limiting the light at the one or more detectable points and simplifying the transfer function that produces the system output.

10. The optical system of claim 1, further comprising:
multiple front-end lenses configured to receive light from one or more spatially distinct points sources; and
multiple mirrors configured to direct light from the multiple front-end lenses, respectively, into the multimode waveguide for transmission in the one or more modes of the multimode waveguide.

11. The optical system of claim 10, further comprising one or more additional waveguides arranged to deliver illumination light to an object at the one or more spatially distinct point sources.

12. The optical system of claim 11, wherein the one or more additional waveguides are selectively illuminated so that illumination light is selectively delivered to portions of the object at the one or more spatially distinct point sources.

13. The optical system of claim 1, wherein the light from the one or more point sources at a front end of the multimode waveguide originates from a laser scanning system at a back end of the multimode waveguide, wherein light originating from the laser scanning system is optically coupled by the back-end lens into the multimode waveguide, transmitted through the multimode waveguide, and directed by front-end lens to the one or more point sources, to thereafter return as light from the one or more point sources.

14. The optical system of claim 1, wherein:
the front-end lens is configured to receive light from the one or more point sources at a focal plane of the front-end lens and output collimated light;
the multimode waveguide is optically coupled to the front-end lens to receive the collimated light at one or more angles relative to a propagation axis of the multimode waveguide and transmit the collimated light through the multimode waveguide in the one or more modes of the multimode waveguide depending on the one or more angles of the collimated light; and
the back end lens is configured to direct the light in each mode of the multimode waveguide to the one or more detectable points at a focal plane of the back end lens.

15. The optical system of claim 14, wherein the one or more point sources are outputs of an optical data transmitter, the optical system further comprising an optical data receiver configured to detect the light at the one or more detectable points, the optical data receiver including:
a detector configured to detect the light at the one or more detectable points and output a detection signal; and
a processor that applies a transfer function to the detection signal to reconstruct a data signal that was transmitted by the optical data transmitter.

16. The optical system of claim 15, wherein the detector is configured to output the detection signal based on light detected only at the one or more detectable points, and the transfer function is calculated to reconstruct the data signal from the detection signal.

17. The optical system of claim 15, wherein the optical data transmitter is configured to output data signals using light that is multiplexed for simultaneous transmission through the multimode waveguide using two or more modes of the multimode waveguide.

18. A method for optical data transmission, comprising:
receiving light from one or more light sources and directing the light by a front-end lens into a multimode waveguide;
transmitting the light through the multimode waveguide in one or more modes of the multimode waveguide;
receiving light that is output from the multimode waveguide and directing the light by a back-end lens to a detector arranged to detect the light at one or more detectable points, wherein the detector outputs a detection signal based on the light detected at one or more detectable points; and
applying a predetermined transfer function to the data in the detection signal to reconstruct output data originally represented in the light from the one or more light source, the output data representing an image of an object or a data signal transmitted by an optical data transmitter.

19. The method of claim 18, further comprising:
monitoring one or more conditions of the multimode waveguide; and
updating the transfer function in response to a change in the one or more conditions of the multimode waveguide.

20. The method of claim 18, further comprising predetermining the transfer function in a calibration step that includes:
evaluating the data in the detection signal with respect to a known image or known data signal that was transmitted in the light from the one or more light sources, and
adjusting a calculation of the transfer function so that application of the transfer function to the detection signal provides for reconstruction of the known image or known data signal.

21. An optical system comprising:
a multimode waveguide having a non-circular cross-sectional core for transmission of light; and
at least one lens optically coupled with the multimode waveguide,
wherein light from one or more point sources is directed by the at least one lens into the multimode waveguide such that the light is transmitted via the core of the multimode waveguide in one or more modes, and
after transmission, the light exiting the multimode waveguide is detected at one or more detectable points.

22. The optical system of claim 21, wherein the at least one lens that directs the light into the multimode waveguide also directs the light exiting the multimode waveguide to the one or more detectable points.

23. The optical system of claim 21, wherein the at least one lens includes a first lens and a second lens, wherein the first lens is arranged to direct the light from the one or more point sources into the multimode waveguide, and the second lens is arranged to focus the light exiting the multimode waveguide in each of the modes to the one or more detectable points.

24. The optical system of claim 23, wherein the first lens, the multimode waveguide, and the second lens are arranged to transmit light from at least two point sources to one detectable point.

25. The optical system of claim 21, wherein the at least one lens and multimode waveguide are implemented in a linear optical quantum computing system in which one or more photon sources at the one or more point sources excite one or more modes of the multimode waveguide and photons transmitted in the multimode waveguide interact to create superposed quantum states that are detectable at the one or more detectable points.

26. The optical system of claim 21, wherein the light from the one or more point sources contains information, the optical system further comprising:
a processor configured to apply a transfer function to a detection signal obtained from detection of the light at the one or more detectable points,
wherein application of the transfer function to the detection signal reconstructs the information, and
wherein the transfer function is determined from a calibration operation in which the information represents a guide object having known geometry and the transfer function is adjusted so that, when applied to the detection signal, the transfer function reconstructs the information representing the guide object within a threshold accuracy.
